(19) United States
(12) Patent Application Publication
(10) Pub. No.: US 2005/0043461 A1
(43) Pub. Date: Feb. 24, 2005

(54) Flame-retardancy-imparting material, flame-retardant polymer material and method for imparting flame retardancy

(75) Inventors: Yoshifumi Yoshida, Nagoya-shi (JP); Tatsuaki Oda, Nagoya-shi (JP)

Correspondence Address: Law Offices of Townsend & Banta, Suite 900, South Building, 601 Pennsylvania Avenue, N.W., Washington, DC, 20004, US

(73) Assignee: Ishizuka Garasu Kabushiki Kaisha

(21) Appl. No.: 10/934,367

(22) Filed: Sep. 7, 2004

Related U.S. Application Data
(63) Continuation-in-part of application No. 10/058,327, filed on Jan. 30, 2002.

(30) Foreign Application Priority Data
Jan. 31, 2001 (JP) 2001-023768
Jan. 31, 2001 (JP) 2001-023939
Jun. 27, 2001 (JP) 2001-194507
Jun. 27, 2001 (JP) 2001-194509
Oct. 10, 2001 (JP) 2001-312885

(51) Int. Cl. C08K 3/28; C08K 3/10; C09K 21/00

(52) U.S. Cl. 524/429; 252/609; 524/437

(57) ABSTRACT

A flame-retardancy-imparting material containing ammonium nitrate and aluminum hydroxide, having a content of the ammonium nitrate of 0.05 to 0.2 parts by weight per one part by weight of the aluminum hydroxide, is provided. The ammonium nitrate has a grain form with an average grain size of 0.01 to 100 μm, and the aluminum hydroxide has a grain form with an average grain size of 0.1 to 100 μm. The ammonium nitrate is surface-treated with silica, and the aluminum hydroxide is surface-treated with a fatty-acid-base treatment agent. Addition of the ammonium nitrate and aluminum hydroxide in combination is successful in obtaining a sufficient flame retardancy even under a small amount of addition.

### RELATED APPLICATION

This application claims the priority of Japanese Patent Application NO. 2001-023768 filed on Jan. 31, 2001, NO. 2001-023939 filed on Jan. 31, 2001, NO. 2001-194507 filed on Jun. 27, 2001, NO. 2001-194509 filed on Jun. 27, 2001, and NO. 2001-312885 filed on Oct. 10, 2001. This application is a continuation-in-part application of U.S. patent application Ser. No. 10/058,327 filed on Jan. 30, 2002.

### FIELD OF THE INVENTION

The present invention relates to a flame-retardancy-imparting material capable of ensuring a material composed of a resin or so an excellent flame retardancy, a flame-retardant polymer material, and a method for imparting flame retardancy.

### DESCRIPTION OF THE BACKGROUND ART

Resin materials are used in a wide variety of fields and demands therefor are still growing for their desirable chemical and physical properties, and for excellent moldability and processability. Most of resin materials are however highly combustible enough to limit the application range thereof, so that there has been a strong demand for providing flame retardancy to such resin materials.

While halogen-base flame retarder has been most popular as a flame retarder for flame retarding finish for resin materials, this type of flame retarder is now understood as undesirable from an environmental viewpoint since it can generate dioxin or furan. So that there is a strong demand for development and practical application of ecological flame retarder. Also phosphorus-base flame retarder, which is of non-halogen-base, is undesirable since it can emit phosphine, a hydride of phosphorus.

There is also known inorganic flame retarder such as aluminum hydroxide and magnesium hydroxide, and in particular aluminum hydroxide enjoys a large demand of all flame retarders since it is advantageous in low hazardousness, low fuming property, electric insulation property and low cost. In approaches of imparting flame retardancy through addition of inorganic flame retarder such as aluminum hydroxide and magnesium hydroxide to a resin or the like, a satisfactory level of flame retardancy is obtainable only when it is added in a large amount to the resin, wherein it is necessary to mix it typically in an amount of 150 parts by weight or more per 100 parts by weight of the resin. This is a most critical drawback of the inorganic flame retarder, and is consequently a reason why the inorganic flame retarder cannot widely be accepted. More specifically, blending of such large amount of inorganic flame retarder to the resin undesirably lowers mechanical strength of the resin, and tends to degrade the waterproof property. Addition of a large amount of inorganic flame retarder raises another problem of increase in viscosity of the compound, which is causative of an adverse effect on moldability of the resin, and raises still another problem in that the combustion of the resin blended with such inorganic flame retarder for the purpose of disposal or so may result in a large amount of deposited combustion residue derived from such inorganic flame retarder.

It is also disadvantageous for the inorganic flame retarders that they need be mixed with other flame retarder since independent use thereof can attain only a small degree of flame retardant effect. There is also known a vitreous flame retarder using a low-melting-point glass, but problems reside in that demanding complicated production process, large amount of addition to the resin and high production cost, and in that achieving only a poor waterproof property.

It is therefore an object of the present invention to solve the foregoing problems and to provide a flame-retardancy-imparting material and a flame-retardant polymer material containing thereof, both of which being aimed at achieving excellent flame retardancy at a low amount of addition to resin or so without degrading various properties of such resin, and low production of combustion residue when such resin or so is combusted for disposal.

### SUMMARY OF THE INVENTION

A flame-retardancy-imparting material of the present invention proposed to solve the foregoing problems is such that being used for ensuring a target object, which mainly comprises a polymer material, flame retardancy as being dispersed therein or immobilized on the surface thereof, and wherein the flame-retardancy-imparting material contains a group expressed as NₓO_{y} (where, x and y are positive integers) (for example, ammonium nitrate) and a group capable of generating water upon heating (for example, aluminum hydroxide).

Such flame-retardancy-imparting material containing a group expressed as NₓO_{y} (where, x and y are positive integers) and a group capable of generating water upon heating can be compounded (added) with a target object such as resin by mixing or immobilization. When such target object is exposed to a high temperature (e.g., 500° C. or above), both of a water component generating group and a nitrogen-containing, combustion-inhibitory gas generated by heating from the group expressed as NₓO_{y} (where, x and y are positive integers) are responsible for providing the target object an excellent flame retardancy in a cooperative manner. More specifically, this successfully allows provision of flame retardancy satisfying a level from V-0 to V-2 when tested in compliance with the procedures of UL-94 combustibility test (this specification follows the fifth edition, Oct. 26, 1996).

In one more preferred embodiment, the group expressed as NₓO_{y} (where, x and y are positive integers) is contained in a form of a compound selected from the group consisting of nitric acid compound, nitrous acid compound and hyponitrous acid compound. More specifically, a compound selected from the group consisting of metal nitrate, nitric acid ester and ammonium nitrate is available. The metal nitrate can be exemplified by zinc nitrate hexahydrate, nickel nitrate hexahydrate, copper nitrate hexahydrate, iron nitrate nonahydrate, aluminum nitrate nonahydrate, cerium nitrate hexahydrate and ammonium cerium nitrate.

The metal nitrate or organic/inorganic nitric acid compound generates nitrogen oxide (NₓO_{y}) upon heating. Possible examples of the organic/inorganic nitric acid compound include acetyl nitrate (C₂H₃NO₄); aniline nitrate (C₆H₈N₂O₃); nitric acid esters (RONO₂) such as methyl nitrate (CH₃ONO₂), ethyl nitrate (C₂H₅ONO₂), butyl nitrate (C₄H₉ONO₂), isoamyl nitrate ((CH₃)₂CHCH₂CH₂ONO₂), isobutyl nitrate ((CH₃)₂CHCH₂ONO₂) and isopropyl nitrate ((CH₃)₂CHONO₂); ammonium nitrate (NH₄NO₃); guanidine nitrate (CH₆N₄O₃); nitroacetylcellulose; nitrocellulose; urea nitrate (HNO₃.CO(NH₂)₂); hydrazinium nitrate (N₂H₅NO₃); hydroxylammonium nitrate ([NH₃OH]NO₃) and benzendiazonium nitrate (C₆H₅N₃O₃). The nitrous acid compound is also available, and examples thereof include ammonium nitrite (NH₄NO₂); and nitrous acid esters (RONO) such as methyl nitrite (CH₃ONO), ethyl nitrite (C₂H₅ONO), propyl nitrite (C₃H₇ONO), isopropyl nitrite ((CH₃)₂CHONO), butyl nitrite (C₄H₉ONO), isobuthyl nitrite ((CH₃)₂CHCH₂ONO) and isoamyl nitrite (amyl nitrite) ((CH₃)₂CHCH₂CH₂ONO). Also the hyponitrous acid compound can be exemplified by metal salt and ammonium salt of hyponitrous ion (N₂O₂²⁻). The nitrogen compound represented by such metal nitrate, and organic/inorganic nitric acid compound is preferably used in a form of dry preparation. Non-dried preparation may degrade moldability and physical properties of the product due to lowered decomposition temperature. While the nitrogen compound is preferably used in a grain form with an average grain size of 0.01 to 100 ìm, those in a form of liquid or solution are also available.

In one more preferred embodiment, the nitric acid compound, nitrous acid compound and hyponitrous acid compound are non-metallic. This desirably prevent a resin, the target substance, from being colored due to addition of the flame-retardancy-imparting material. Coloring is probably ascribable to metal ion. For example, non-metallic ammonium nitrate (NH₄NO₃) is proper as the nitric salt used in the present invention since it is inexpensive and is not causative of such coloring of the target substance. In contrast, intentional use of coloring by the metal nitrate will be valuable for the case the coloring of the target substance is desired. Some of the metal nitrate have a decomposition temperature higher than that of non-metallic nitrate, so that they are advantageous in that allowing setting of the molding temperature of the resin material at a relatively higher level. It is thus recommendable to selectively use the non-metallic nitrate or metallic nitrate by purposes. Anyway such coloring by no means indicates ruining of the flame retardancy and moldability of the target object.

In one more preferred embodiment, the nitric acid compound, nitrous acid compound and hyponitrous acid compound are subjected to surface treatment for improving the affinity with the target object. The surface treatment is preferably given by using any one agent selected from the group consisting of those of Si-base, Ti-base, Al-base, olefin-base, fatty-acid-base, oil-and-fat-base, wax-base and surfactant-base. Specific examples thereof include those using silane coupling agent, titanate-base coupling agent or aluminate-base coupling agent; those using fatty-acid such as stearic acid, oleic acid, linoleic acid, linolenic acid or eleostrearic acid; those using salt of fatty-acid such as Ca salt or Zn salt of the foregoing fatty-acids; those using nonionic surfactant such as polyethylene glycol derivative; those using polyethylene-base or polypropylene-base wax; carboxylate-base coupling agent and phosphate-base coupling agent.

It is also allowable to subject the nitric acid compound, nitrous acid compound and hyponitrous acid compound to surface treatment with silica, in order to improve the moisture-proof property. In particular for the case where ammonium nitrate is used as the nitric acid compound, it is preferable to grind it so as to achieve an average grain size of 0.01 to 100 μm, and to further subject it to the surface treatment (moisture-proofing treatment) with silica.

More specifically, the surface treatment may be coating with a vitreous precursor composition capable of generating vitreous ceramic upon heating onto such nitrogen compound. When the target object is exposed to a high temperature (e.g., 500° C. or above), such vitreous precursor composition produces vitreous ceramic, and such vitreous ceramic serves as a protective film to thereby allow the target object to have an excellent flame retardancy.

The vitreous precursor composition is such that containing silicon component and/or metal component together with oxygen, and the resultant vitreous ceramic obtained by heating is such that being mainly composed of silicon oxide and/or metal oxide. Since the silicon component and/or metal component is likely to produce a vitreous ceramic through oxidation by heating, and the resultant vitreous ceramic mainly composed of silicon oxide and/or metal oxide is excellent in heat resistance, so that the vitreous precursor composition used for the surface treatment in the present invention is particularly preferable when it contains silicon component and/or metal component together with oxygen. The metal component herein can be any one or combination of two or more of Ti, Cu, Al, Zn, Ni, Zr and other transition metals. The vitreous ceramic may preliminarily be contained in the compound as a part thereof, or may exist in a form such that allowing conversion into such vitreous ceramic only after a part or the entire portion of the compound is heated. So-called sol-gel process is one possible method for the surface treatment with such vitreous precursor composition.

Another surface treatment relates to such that coating the nitrogen compound using stearic acid as a fatty-acid-base agent. Thus surface-treated nitrogen compound will be improved in the compatibility (affinity) with the target object such as resin or so, which allows the nitrogen compound to be dispersed in or immobilized on the target object in a uniform manner. The surface treatment with stearic acid can be effected by, for example, mixing 100 parts by weight of the nitrogen compound with 0.01 to 1 parts by weight of stearic acid under stirring, and then heating the mixture within a temperature range from 70 to 80° C.

The flame-retardancy-imparting material of the present invention may also be such that containing a product obtained by reacting a compound having a group expressed as NₓO_{y} (where, x and y are positive integers) with a compound having a group capable of generating water upon heating. For example, it may be a nitric-acid-base composite compound obtained by reacting a hydroxide with nitric acid, and more specifically, a compound having in a single molecule at least a hydroxyl group and/or a group with crystal water, and a group expressed as NₓO_{y} (where, x and y are positive integers).

In one more preferred embodiment, the group capable of generating water upon heating is contained in a form of a hydroxyl-group-containing compound. Metal hydroxide is recommendable for such hydroxyl-group-containing compound. More specifically, it is exemplified by a compound mainly comprising at least one compound selected from the group consisting of aluminum hydroxide, magnesium hydroxide and calcium hydroxide. That is, any mixtures comprising two or more compounds selected from aluminum hydroxide, magnesium hydroxide and calcium hydroxide are also allowable. It is still also allowable to use a compound having in its composition two or more metal elements. Possible examples thereof include calcium aluminate hydrate (3CaO.Al₂O₃.6H₂O) and hydrotalcite (Mg₆Al₂(OH)₁₆CO₃.4H₂O). Now such hydrotalcite (Mg₆Al₂(OH)₁₆CO₃.4H₂O) is referred to as a compound which contains hydroxyl groups and crystal waters, and contains a plurality of metal elements in the composition thereof. The hydroxyl-group-containing compound and hydrate compound used herein preferably have a granular form with an average grain size of 0.1 to 100 μm.

Other examples available for the present invention include metal hydroxide selected from zinc hydroxide, cerium hydroxide, iron hydroxide, copper hydroxide, titanium hydroxide, barium hydroxide, beryllium hydroxide, manganese hydroxide, strontium hydroxide, zirconium hydroxide and gallium hydroxide; mineral such as boehmite containing such metal hydroxide; and basic magnesium carbonate.

Of course the foregoing surface treatment can be applied to the hydroxyl-group-containing compound composing the flame-retardancy-imparting material. In particular for the case where aluminum hydroxide is used as the hydroxyl-group-containing compound, it is preferable to grind it so as to achieve an average grain size of 0.1 to 100 μm, and to further subject it to the surface treatment with a fatty-acid-base treatment agent. This facilitates blending with the polymer material.

Next, a flame-retardant polymer material of the present invention is such that having a matrix which comprises a polymer material and has dispersed therein a flame-retardancy-imparting material which contains a group expressed as NₓO_{y} (where, x and y are positive integers) and a group capable of generating water upon heating.

Another flame-retardant polymer material of the present invention is such that having a matrix which comprises a polymer material and has immobilized on the surface thereof a flame-retardancy-imparting material which contains a group expressed as NₓO_{y} (where, x and y are positive integers) and a group capable of generating water upon heating. Such flame-retardancy-imparting material can partially be immobilized on the surface of the matrix and can partially be dispersed in such matrix.

Still another flame-retardant polymer material of the present invention is such that having a matrix which comprises a polymer material and has immobilized thereon a flame-retardancy-imparting material which contains a compound selected from the group consisting of nitric acid compound, nitrous acid compound and hyponitrous acid compound, together with a hydroxyl-group-containing compound.

Such polymer materials having added thereto the flame-retardancy-imparting material of the present invention can retain an excellent moldability without ruining the intrinsic properties thereof. The present invention can also provide a masterbatch which is a grain-formed molded product containing a polymer matrix having dispersed therein the flame-retardancy-imparting material, and which is used for molding to thereby obtain a product having a secondary form and a volume larger than that of the individual grain.

It is to be noted that the flame-retardancy-imparting material of the present invention can be used in combination with conventional inorganic and/or organic flame retarders. Specific examples of such known flame retarders include inorganic flame retarders typified by micas such as muscovite, phlogopite, biotite and sericite; minerals such as kaoline, talc, zeolite, borax, diaspore and gypsum; metal oxides such as magnesium oxide, aluminum oxide, antimony oxide and silicon dioxide; metal compounds such as calcium carbonate; zinc-base flame retarders such as zinc borate, zinc sulfate and zinc stannate; phosphorus-base compounds such as red phosphorus, ester of phosphoric acid and ammonium polyphosphate; and vitreous flame retarders containing low-melting-point glass; organic flame retarders typified by those of phosphorus-base, silicone-base and nitrogen-base; and metal powders.

In another aspect, the flame-retardancy-imparting material of the present invention is such that being used for ensuring a target object, which mainly comprises a polymer material, flame retardancy as being dispersed therein or immobilized on the surface thereof, wherein the flame-retardancy-imparting material contains a combustion-inhibitory oxidative decomposition accelerator which oxidatively decomposes such polymer material upon heating to thereby ensure such target object combustion-inhibitory property.

Another flame-retardancy-imparting material of the present invention is such that being used for ensuring a target object, which mainly comprises a polymer material, flame retardancy as being dispersed therein or immobilized on the surface thereof, wherein the flame-retardancy-imparting material contains a combustion-inhibitory oxidative decomposition accelerator which oxidatively decomposes such polymer material at the combustion temperature of the polymer material or at a lower temperature than such combustion temperature to thereby ensure such target object combustion-inhibitory property.

The flame-retardancy-imparting material containing such combustion-inhibitory oxidative decomposition accelerator can be compounded (added) with a target object by, for example, mixing or immobilization. When such target object is exposed to a high temperature (e.g., approx. 200 to 500° C., or higher), the combustion-inhibitory oxidative decomposition accelerator is activated by the heat to oxidatively decompose the target object (thermal oxidative decomposition), to thereby provide the target object an excellent flame retardancy. Here the flame retardancy is provided through oxidation without being associated with flame before the target object starts to burn in flame, and the combustion-inhibitory oxidative decomposition is supposed to proceed during the temperature elevation and before combustion in flame. In more detail, the combustion-inhibitory oxidative decomposition accelerator oxidatively decomposes the target object during or immediately before the combustion of such target object to thereby denature the target object into non-combustible components such as CO₂ and H₂O. It is to be understood now that combustion in the context of the present invention typically refers to such that proceeding in the air and being associated with flame. Such flame-retardancy-imparting material of the present invention can provide an excellent flame retardancy in a small amount of addition, which is advantageous in that avoiding degradation of various properties of the target object and reducing the production cost.

The combustion-inhibitory oxidative decomposition accelerator can contain an oxidant. In this case, flame retardancy is provided through oxidative decomposition of the target object by such oxidant. Such oxidant can be at least one compound selected from the group consisting of nitric acid, nitric acid compound, permanganate, chromic acid, chromic acid compound, peroxide, salt of peroxoacid, salt of sulfuric acid, oxygen-base substance and oxide. Specific examples thereof include HNO₃, HNO₂, N₂O₃, N₂O₄, KMnO₄, MnO₂, Mn(CH₃CO₂)₃, CrO₃, Na₂Cr₂O₇, H₂O₂, Na₂O₂, (C₆H₅CO)₂O₂, CH₃CO₃H, C₆H₅CO₃H, K₂S₂O₈, Fe₂(SO₄)₃, O₂, PbO, HgO, AgO and Ag₂O.

The combustion-inhibitory oxidative decomposition accelerator may be such that containing a nitrogen compound and a hydroxyl-group-containing compound. In this case, the target object is given with the flame retardancy through a process in which, during or before the combustion of such target object, the nitrogen compound generates a nitrogen oxide, the hydroxyl-group-containing compound generates water, such nitrogen oxide and water then react with each other to produce nitric acid, and such nitric acid denatures the polymer material by thermal oxidation to produce non-combustible components such as CO₂ and H₂O. It is to be understood now that “denaturalization” in the context of this specification also includes changes caused by chemical reaction associated with breakage of covalent bond.

More specifically, for the case a metal hydroxide is used as the hydroxyl-group-containing compound, the nitrogen compound is preferably a nitric acid compound having a decomposition temperature of 50 to 600° C. Since most of metal hydroxide have a decomposition temperature at approx. 400° C. or below, and will cause dehydration when heated to approx. 400° C. So that using such nitric acid compound having a decomposition temperature of 50 to 400° C. as the nitrogen compound allows smooth progress of the reaction between the independently generated nitrogen oxide and water. For the case that aluminum hydroxide (decomposition temperature is approx. 300° C.) is used as the metal hydroxide, the nitrogen compound preferably has a decomposition temperature of 50 to 350° C., and more preferably 100 to 300° C. For the case that magnesium hydroxide (decomposition temperature is approx. 350° C.) is used as the metal hydroxide, the nitrogen compound is preferably a nitric acid compound having a decomposition temperature of 50 to 400° C., and more preferably 200 to 400° C. for the same reason. The nitric acid compound can be selected from those listed in the above. The same will apply to the foregoing hydroxyl-group-containing compound.

The combustion-inhibitory oxidative decomposition accelerator can be contained in an amount of 150 parts by weight or below per 100 parts by weight of the target object. In the conventional procedure for adding an inorganic flame retarder such as aluminum hydroxide, a necessary amount of blending thereof was as much as 150 to 200 parts by weight or around per 100 parts by weight of the target object. On the contrary, the flame-retardancy-imparting material of the present invention containing a nitrogen compound and a hydroxyl-group-containing compound can efficiently provide the flame retardancy, so that an amount of addition of such combustion-inhibitory oxidative decomposition accelerator of only as small as 150 parts by weight or below per 100 parts by weight of the target object will successfully result in a sufficient level of flame retardancy, which may be even attainable by the addition of 100 parts by weight or below, and even by 50 parts by weight or less in some cases. More specifically, the amount of addition of the combustion-inhibitory oxidative decomposition accelerator is preferably within a range typically from 5 to 150 parts by weight, more preferably 10 to 100 parts by weight, and still more preferably 20 to 80 parts by weight, where a particularly preferable range resides in a range from 30 to 70 parts by weight. The more the amount of addition increases, the more the target object becomes sensitive to property changes and the cost becomes large. On the contrary, too small amount of addition may fail in providing a sufficient level of flame retardancy, so that the amount of addition is preferably adjusted within the foregoing ranges.

That is, the flame-retardancy-imparting material of the present invention is preferably added to 100 parts by weight of the target object to be provided with flame retardancy so as to attain contents of the nitrogen compound of 0.1 to 50 parts by weight and hydroxyl-group-containing compound of 10 to 100 parts by weight. A content of the nitrogen compound of less than 0.1 parts by weight may degrade the efficiency in providing flame retardancy, and exceeding 50 parts by weight may result in cost increase. A preferable range of content of the nitrogen compound is 1 to 20 parts by weight or around. On the other hand, a content of the hydroxyl-group-containing compound of less than 10 parts by weight may degrade the efficiency in providing flame retardancy, and exceeding 100 parts by weight may undesirably modify properties of the target object. More specifically, mechanical strength or moldability of the target object may be ruined. This is also disadvantageous in that a large amount of combustion residue may deposit within an incinerator. A preferable range of content of the hydroxyl-group-containing compound is 30 to 70 parts by weight or around.

The flame-retardancy-imparting material of the present invention preferably has a content of the nitrogen compound (for example, ammonium nitrate ) of 0.05 to 0.2 parts by weight per one part by weight of the hydroxyl-group-containing compound (for example, aluminum hydroxide). The content of the nitrogen compound of less than 0.05 parts by weight per one part by weight of the hydroxyl-group-containing compound may result in a degraded imparting ability of flame retardancy. On the other hand, the content of the nitrogen compound exceeding 0.2 parts by weight may result in only a limited range of improvement in the flame retardant ability against expectation as judged from the amount of addition, or may result in modified properties of the target material.

Since the flame-retardancy-imparting material preferably has the content of the nitrogen compound of 0.05 to 0.2 parts by weight per one part by weight of the hydroxyl-group-containing compound, when the content of the hydroxyl-group-containing compound (for example, aluminum hydroxide) is in the range from 10 to 100 parts by weight per 100 parts by weight of the polymer material, the content of the nitrogen compound (for example, ammonium nitrate) is preferably in the range from 0.5 to 20 parts by weight. In the same manner, when the content of the hydroxyl-group-containing compound is in the range from 30 to 70 parts by weight per 100 parts by weight of the polymer material, the content of the nitrogen compound is preferably in the range from 1.5 to 14 parts by weight.

In another aspect, the flame-retardant polymer material of the present invention is such that mainly comprising a polymer component, wherein such flame-retardant polymer material shows in a spectrum of TDS analysis (thermal decomposition spectroscopy) in vacuo a peak attributable to a combustion-related gas component generated within a combustion temperature range of the polymer component, and a peak attributable to a combustion-inhibitory gas component containing at least a group expressed by COₓ (x is a positive integer) and generated within a temperature range lower than the combustion temperature range of the polymer component.

Some of the conventional flame-retardant polymer material have added therein a metal hydroxide, such as aluminum hydroxide, which decomposes upon heating to generate water. Heating of such polymer materials can generate H₂O within a temperature range lower than the combustion temperature range thereof. Heating of the flame-retardant polymer material of the present invention will produce at least combustion-inhibitory gas expressed as COₓ, which is typified by CO and CO₂. The combustion-inhibitory gas also contains other components such as H₂O and NOₓ (where, x represents a positive integer, and typically NO, NO₂, etc.). Since COₓ is non-combustible as being generally understood, it can be responsible for creating a flame-retardant atmosphere and inhibiting combustion (drastic oxidation) of the polymer material. Flame-retardant effect of the flame-retardant polymer material of the present invention can thus be confirmed also from the TDS analysis. The combustion-related gas component can be exemplified at least by those having a group expressed as CₙHₘ (where, n and m are positive integers, and typically CH₄, C₂H₆, C₃H₈, etc.). It is to be noted now that COₓ detected in the TDS analysis is not ascribable to residual COₓ remaining after the measurement apparatus is evacuated from the normal atmosphere to vacuum.

The temperature range lower than the combustion temperature range of the polymer component can typically be a range lower by 50 to 400° C. Note that such difference of the temperature range depends on the rate of temperature elevation in the TDS analysis, and the foregoing range is attained at a standard rate of temperature elevation in TDS analysis of the polymer material, which is typified as 500° C./min. The combustion initiation temperature of the polymer component can be defined as a temperature whereat hydrocarbon or CO₂ vigorously starts to generate when the polymer component is heated in the air.

In another aspect, the flame-retardant polymer material of the present invention is such that mainly comprising a polymer component, wherein such flame-retardant polymer material shows a spectrum of TDS analysis (thermal decomposition spectroscopy) in vacuo in which a peak profile attributable to a combustible gas component generated by decomposition reaction of the polymer component; and a peak profile attributable to a non-combustible gas component generated as a decomposition product of the polymer component within a temperature range lower than that responsible for the start of the generation of such combustible gas component.

The target object of the measurement will never ignite nor burn when the combustion temperature thereof is attained in the TDS analysis in vacuo, since there is almost no oxygen. The target object of the measurement which is no more combustible will then cause breakage of the covalent bonds, and elimination of the decomposition products. The same will apply to a polymer without being provided with flame retardancy. The flame-retardant polymer material of the present invention can generate the non-combustible gas in the temperature range lower than the temperature range in which such decomposition and elimination occur. This allows the polymer material to be exposed to a flame-retardant atmosphere, to thereby exhibit the flame-retardant effect in the air. Similarly in the lower temperature range, a part of the polymer material is decomposed and emitted as the non-combustible gas component. Such process competes with the combustion (drastic oxidation) to thereby inhibit the combustion, which results in a desirable flame-retardant effect.

### BRIEF DESCRIPTION OF THE DRAWINGS

FIG. 1A is a schematic drawing showing an exemplary production process of a masterbatch comprising a flame-retardant polymer material compounded with a flame-retardancy-imparting material of the present invention;

FIG. 1B is a schematic drawing showing a grain form of the masterbatch;

FIG. 1C is a schematic drawing showing another grain form of the masterbatch;

FIG. 1D is a schematic drawing showing still another grain form of the masterbatch;

FIG. 2A is a first schematic drawing showing an exemplary form of the flame-retardancy-imparting material;

FIG. 2B is a second schematic drawing of the same;

FIG. 2C is a third schematic drawing of the same;

FIG. 3 is a schematic sectional view showing an exemplary constitution of an injection molding machine;

FIG. 4 is a process diagram showing an exemplary production process of a molded product by injection molding;

FIG. 5A is a first drawing for explaining an exemplary style of use of the masterbatch;

FIG. 5B is a second drawing of the same;

FIG. 6A is a drawing for explaining a method for obtaining a flame-retardant polymer material blended with a flame-retardancy-imparting material of the present invention using a two-part mixing resin;

FIG. 6B is a drawing as continued from FIG. 6A;

FIG. 6C is a drawing as continued from FIG. 6B;

FIG. 6D is a drawing as continued from FIG. 6C;

FIG. 7A is a first drawing for explaining a method for immobilizing a flame-retardancy-imparting material on the surface of a polymer matrix;

FIG. 7B is a second drawing of the same;

FIG. 7C is a third drawing of the same;

FIG. 7D is a fourth drawing of the same;

FIG. 7E is a fifth drawing of the same;

FIG. 8 is a drawing for explaining an exhibition mechanism of flame retardancy of a flame-retardancy-imparting material of the present invention;

FIG. 9A is a first drawing showing results of TDS measurement;

FIG. 9B is a second drawing of the same;

FIG. 9C is a third drawing of the same;

FIG. 10A is an MS spectrum for the time of decomposition;

FIG. 10B is another MS spectrum of the same;

FIG. 10C is still another MS spectrum of the same;

FIG. 11A is a three-dimensional expression of the spectrum shown in FIG. 10A;

FIG. 11B is a three-dimensional expression of the spectrum shown in FIG. 10B;

FIG. 11C is a three-dimensional expression of the spectrum shown in FIG. 10C;

FIG. 12A is a drawing showing results of temperature-wise measurement of generation status of m/z=30;

FIG. 12B is a drawing showing results of temperature-wise measurement of generation status of m/z=46;

FIG. 13A is a drawing showing results of temperature-wise measurement of generation status of m/z=28;

FIG. 13B is a drawing showing results of temperature-wise measurement of generation status of m/z=44;

FIG. 14A is a drawing showing results of temperature-wise measurement of generation status of m/z=18, 28, 30;

FIG. 14B is a drawing showing results of temperature-wise measurement of generation status of m/z=28, 30, 44, 46;

FIG. 15 is a drawing showing results of temperature-wise measurement of generation status of m/z=26, 27, 28;

FIG. 16A is a drawing showing results of TG-MS measurement in a He atmosphere at 300° C.;

FIG. 16B is another drawing of the same;

FIG. 16C is still another drawing of the same;

FIG. 17 is a drawing showing results of TG-MS measurement in an O₂ atmosphere at 300° C.;

FIG. 18 is a drawing showing results of GC-MS measurement at 480° C.;

FIG. 19 is a drawing showing weight changes of a composition containing polyethylene, aluminum hydroxide and nitric acid compound during a temperature elevation process;

FIG. 20 is a drawing for explaining an exhibition mechanism of flame retardancy of a flame-retardancy-imparting material of the present invention;

FIG. 21 is a graph showing relations between ratio of weight of aluminum hydroxide and ammonium nitrate (NH₄NO₃/Al(OH)₃) and oxygen index (OI);

FIG. 22 is a drawing for explaining a measuring method based on UL 94; and

FIG. 23 is a drawing for explaining a measuring method based on JIS K-7201.

### BEST EMBODIMENTS FOR CARRYING OUT THE INVENTION

Best embodiments for carrying out the present invention will be detailed referring to the attached drawings.

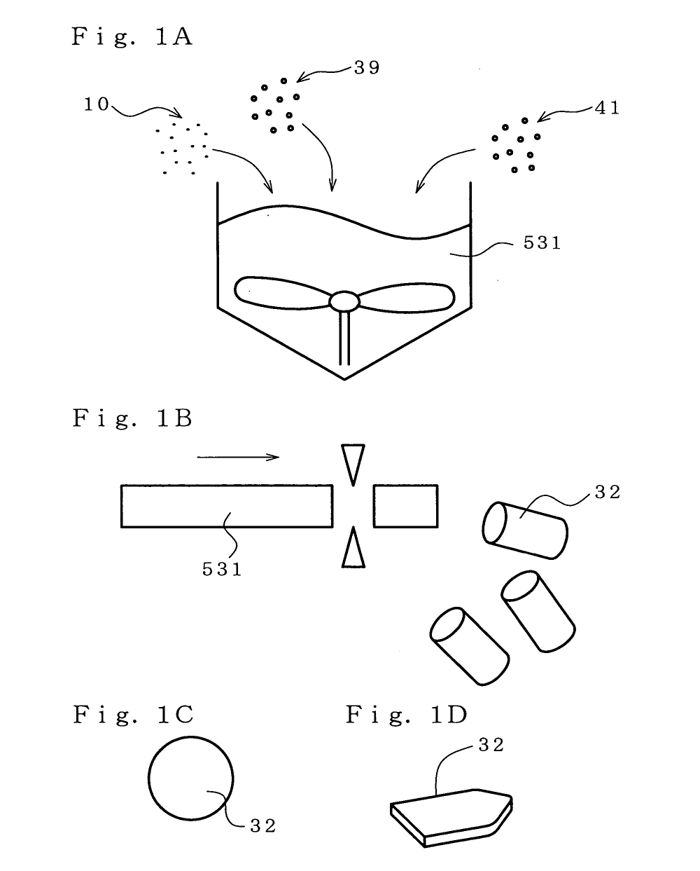

FIGS. 1A to 1D are schematic drawings showing an exemplary production process of a masterbatch comprising a flame-retardant polymer material compounded with a flame-retardancy-imparting material of the present invention, together with various forms of the masterbatch grain. Ammonium nitrate powder 10 (corresponded to the nitric acid compound, and thus to the nitrogen compound) and aluminum hydroxide powder 39 (corresponded to the hydroxyl-group-containing compound), both of which are flame-retardancy-imparting materials, are blended and kneaded with a polymer material 41 which should serve as a matrix (preferably polyethylene which is a thermoplastic resin, for example), to thereby obtain a compound 531. It is to be noted now that the flame-retardancy-imparting material can also be a mixture obtained by preliminarily mixing the ammonium nitrate powder 10 and aluminum hydroxide powder 39 at a predetermined blending ratio. Preferable blending ratios will be described later in Experimental Examples. The compound 531 may contain inevitable impurities.

The compound 531 can be molded into a grain form such as pellet or the like which is available as a masterbatch grain 32. The masterbatch grain 32 typically has a grain size of approx. 0.1 to 10 mm (more specifically approx. 1 to 4 mm) as being expressed by the diameter of an equivalent virtual sphere. While the shape of the masterbatch grain 32 is not specifically limited, the masterbatch grain 32 can typically be obtained by extruding the softened compound in a strand form, and then cutting the obtained strand into a predetermined length so as to form a columnar (cylindrical) grain, as shown in FIG. 1B. FIGS. 1C and 1D show other examples of the grain form, where the former shows a spherical form (typically obtainable by die casting), and the latter shows a flaky one (typically obtainable by crushing and shaping of a sheet-formed compound), while being not limited thereto.

The ammonium nitrate powder (ammonium nitrate grain) 10 and aluminum hydroxide powder (aluminum hydroxide grain) 39 may be subjected to surface treatment. One possible surface treatment agent is such that containing at least carbon component and that being capable of improving affinity between the polymer material 41 and ammonium nitrate powder (ammonium nitrate grain) 10. More specifically, any one compound selected from the group consisting of those of silane-base, titanate-base, aluminum-base, zirco-aluminum-base, olefin-base, fatty-acid-base, oil-and-fat-base, wax-base and surfactant-base is available.

It is also allowable to subject the ammonium nitrate powder (ammonium nitrate grain) 10 to surface treatment with silica for the purpose of improving the moisture-proofing property. On the other hand, it is particularly preferable to subject the aluminum hydroxide powder (aluminum hydroxide grain) 39 to surface treatment with a fatty-acid-base treatment agent for the purpose of improving the affinity with the polymer material 41.

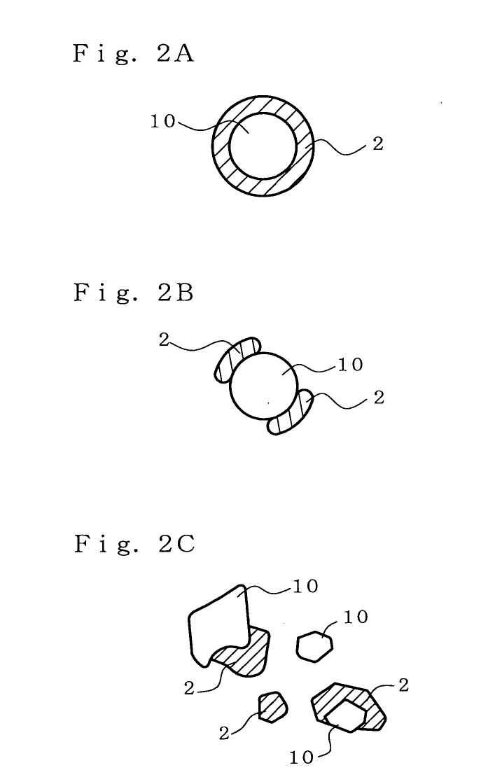

One possible example of such surface treatment relates to coating of a vitreous precursor composition based on the sol-gel process, where the composition contains silicon component and/or metal component together with oxygen, and capable of producing vitreous ceramic typically by heating. FIGS. 2A to 2C are schematic drawings showing various styles of the coating onto the ammonium nitrate grain 10. The ammonium nitrate grain 10 has compounded on the surface thereof a vitreous precursor composition 2. While the grain 10 herein is schematically illustrated as a sphere, the grain shape can widely vary depending on the production process, and it is often that the grain will not always be spherical. Possible compounding style of the vitreous precursor composition 2 and ammonium nitrate grain 10 may be such that the vitreous precursor composition 2 uniformly covers almost entire surface of the ammonium nitrate grain 10 as shown in FIG. 2A, or such that the vitreous precursor composition 2 adheres partially on the surface of the ammonium nitrate grain 10 while leaving the residual surface uncovered and exposed as shown in FIG. 2B. Or, the shape of the ammonium nitrate grain 10 may be irregular as shown in FIG. 2C, which may be obtainable by crushing or cracking the spherical ammonium nitrate shown in FIG. 2A. Anyway, the target object is successfully provided with flame retardancy if such ammonium nitrate grain 10 and aluminum hydroxide powder 39 are compounded for example with a matrix (dispersion into and/or immobilization onto the matrix) of such target object composed for example of a polymer material. Note that the target object composed of a polymer material may be added with various additives, which may be inorganic or organic materials.

In the example shown in FIG. 2A, the thickness of the vitreous precursor composition 2 covering or adhering onto the ammonium nitrate grain 10 is approx. 0.01 to 1.0 μm. Flame-retardant effect of the flame-retardancy-imparting material containing such ammonium nitrate grain 10 and aluminum hydroxide grain 39 (see FIG. 1A) is extremely large. So that the flame-retardancy-imparting material can be added to the target object, which mainly comprises a polymer material, typically in an amount of 5 to 150 parts by weight, more preferably 10 to 100 parts by weight, still more preferably 20 to 80 parts by weight, and most preferably 30 to 70 parts by weight per 100 parts by weight of such target object. Such small amount of addition is advantageous in that being less causative of characteristic changes of the target object such as resin, and in that ensuring cost reduction to a considerable degree.

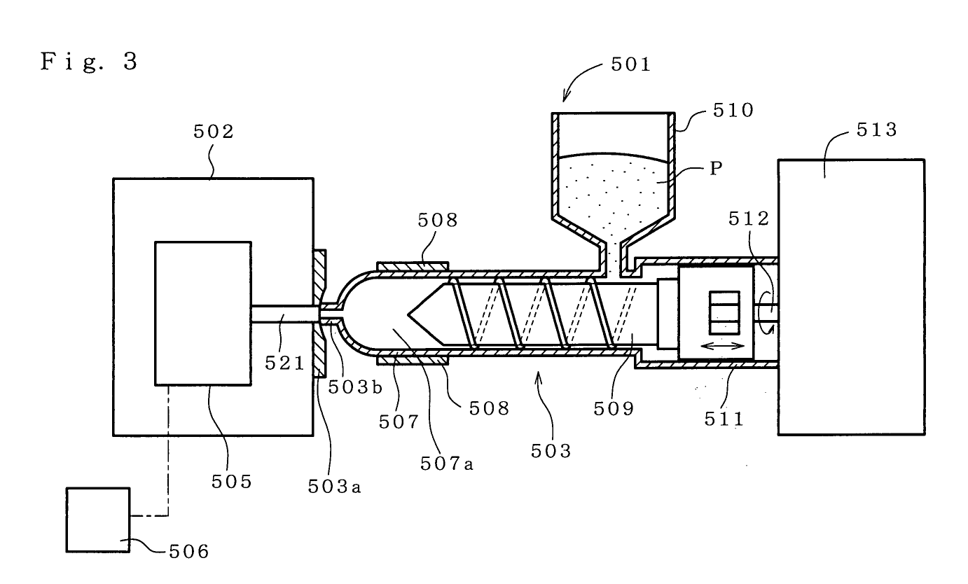

Next, an exemplary production process of molded product (secondary molded product) using the masterbatch shown in FIGS. 1B to 1D will be explained referring to a case in which an injection molding machine shown in FIG. 3 is used. It is a matter of course that any known molding processes can be adopted depending of purposes, and the molded product can be obtained typically by compression molding, transfer molding, extrusion molding, blow molding, calender molding, laminate molding and sheet forming.

In an example shown in FIG. 3, an injection molding machine 501 comprises a molding section 502 and a injection apparatus 503 for feeding molten resin to the molding section 502, which is typified by a screw injection apparatus. The molding section 502 further comprises a die 505, and a drive mechanism 506 which comprises a mechanical drive mechanism such as a cam or crank mechanism and a hydraulic mechanism such as a hydraulic cylinder, both of which are provided for clamping or opening such die 505. A runner 521 for feeding molten resin to such die 505 has connected thereto an injection nozzle 503b of the injection apparatus 503 via a sprue 503a.

In the injection apparatus 503, a feeding screw 509 driven by a hydraulic motor 513 as being transmitted by a shaft 512 is housed in a heating cylinder 507 which is heated by a heat source such as a band heater 508, and a hopper 510 for feeding masterbatch P is attached thereto. The masterbatch P is fed from the hopper 510 as the screw 509 rotates, and a polymer matrix is melted by heating within the heating cylinder 507 to produce a molten compound, which is then pooled in a pooling portion 507a. Advancing now the screw 509 in a predetermined length with the aid of the hydraulic cylinder 511 allows a predetermined amount of the molten compound to be injected within the die 505 through the runner 521.

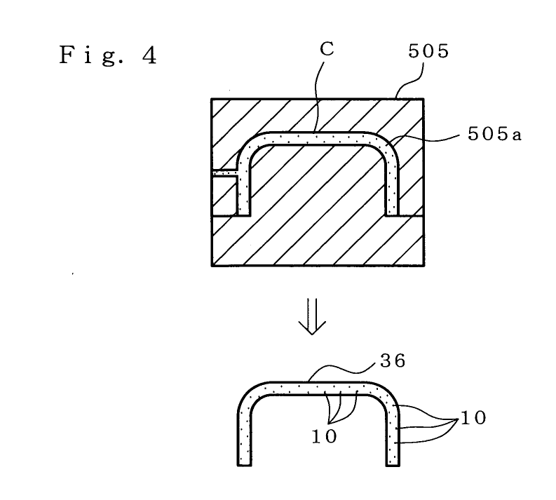

As shown in FIG. 4, the molten compound C injected into a cavity 505a of the die 505 can form a polymer material compounded with the flame-retardancy-imparting material of the present invention as the polymer matrix solidifies, and opening of the die 505 will yield a secondary molded product 36 as a polymer molded product conforming to the morphology of the cavity. Temperature of such injection molding is selected as lower than the decomposition temperature of the nitric acid compound included in the flame-retardancy-imparting material.

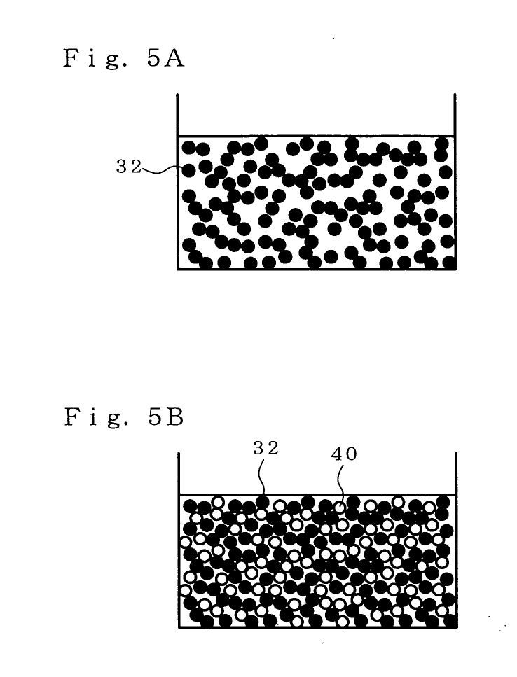

While the masterbatch grain 32 can independently be used to obtain the molded product as shown in FIG. 5A, it is also allowable to properly mix therewith a dilution polymer material grain 40 so as to produce a secondary molded product having a content of the compound grain lower than that in the masterbatch grain 32, where such dilution polymer material grain 40 comprises a polymer material same as or different from the polymer matrix composing such masterbatch grain as shown in FIG. 5B. In this case, the content of the compound grain in the resultant secondary molded product is determined by the content of such compound grain in the masterbatch grain 32 and a compounding ratio of the dilution polymer material grain 40 in respect of the masterbatch grain 32.

The content of the compound grain in the masterbatch grain to be diluted is as high as 20 to 67 wt % on the weight basis, so that it is preferable to blend a dispersion aid so as to uniformly disperse the compound grain at such a high content. Metallic soap is an example of preferable dispersion aid. The metallic soap can be exemplified as those having an organic acid component selected from naphthenic acid (naphthenate), lauric acid (laurate), stearic acid (stearate), oleic acid (oleate), 2-ethylhexanic acid (octate), fatty acid in linseed oil or soybean oil (linolate), tall oil (tollate) and rosin (rosinate) Examples of metal component are as listed below:
naphthenates (Al, Ca, Co, Cu, Fe, Pb, Mn, Zn, etc.);
rosinates (Al, Ca, Co, Cu, Fe, Pb, Mn, Zn, etc.);
linolates (Co, Fe, Pb, Mn, etc.);
stearates (Ca, Zn, etc.);
octates (Ca, Co, Fe, Pb, Mn, Zn, etc.); and
tallate (Ca, Co, Fe, Pb, Mn, Zn, etc.).

Of these, copper stearate and zinc stearate can be exemplified as specific examples of the metallic soap particularly excellent in dispersion effect (stearic acid treatment). It is to be noted that an excessive compounding of the metallic soap will raise a problem in material strength and homogeneity, and too small amount of compounding will result in insufficient dispersion effect, so that it is preferable to select the amount of compounding within a range typically from 0.01 to 3 wt % (more specifically, 0.3 wt %) so as to avoid such disadvantages.

Besides the foregoing examples, it is also allowable to separately prepare masterbatch A (not shown) having blended therein ammonium nitrate powder 10 and polymer material 41, and masterbatch B (not shown) having blended therein aluminum hydroxide powder 39 and polymer material 41, and then to mix both masterbatches A and B to thereby obtain a molded product. It is still also allowable to blend masterbatch A with aluminum hydroxide powder 39, or to blend masterbatch B with ammonium nitrate powder 10.

It is also allowable to compose the flame-retardant polymer material having compounded therein the flame-retardancy-imparting material of the present invention with a molding resin material, adhesive or paint of two-part-mixing type, which individually comprises a principal agent containing an uncured resin component such as epoxy resin, urethane resin (including urethane rubber) or silicone resin, and a curing agent for curing such uncured resin component.

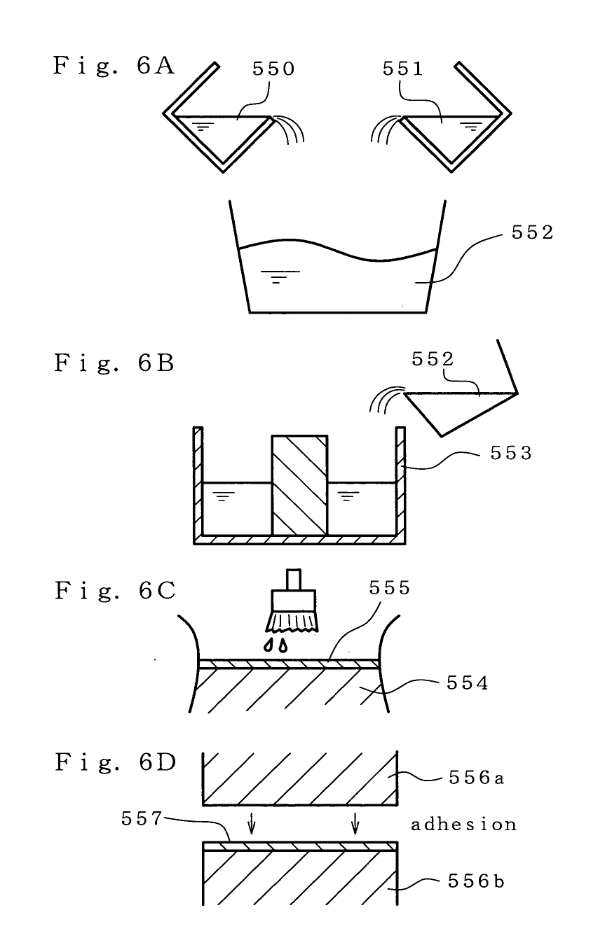

A specific example of production of such molding material using epoxy resin will be explained referring to FIGS. 6A to 6D. A principal agent 550 comprises an uncured bisphenol-base epoxy resin component having contained therein the flame-retardancy-imparting material together with optional additives such as flame-retardant auxiliary, filler, coloring matters such as pigment or dye, and dispersion aid; where the viscosity of which being adjusted by a proper solvent. On the other hand, a curing agent 551 comprises a curing component such as amine, isocyanate or acid anhydride as being dissolved or dispersed in a solvent. Both agents 550, 551 are mixed in a predetermined ratio immediately before use as shown in FIG. 6A, and the obtained mixed composition 552 is subjected to necessary treatment depending on purposes within a pot life time thereof. For example, if the mixed composition 552 is to be used as a molding resin material, it will be poured into the die 553 so as to obtain a molded product of the flame-retardant polymer material having a desired shape as shown in FIG. 6B. For the mixed composition 552 intended for a paint, it will be coated on a target plane of an object to be painted 554 and then cured so as to obtain a paint film 555 of the flame-retardant polymer material as shown in FIG. 6C. Or, for the mixed composition 552 intended for an adhesive, it will be coated on target planes of objects to be bonded 556a, 556b so as to obtain an adhesion structure in which a resultant flame-retardant adhesive layer 555 binds both objects to be bonded 556a, 556b as shown in FIG. 6D.

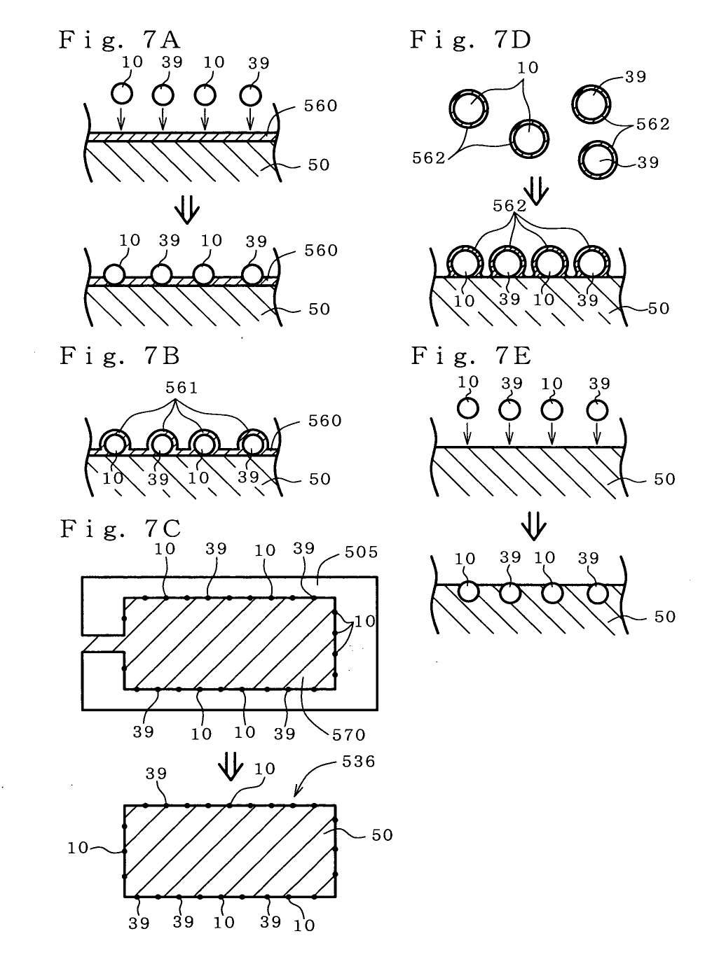

The flame-retardancy-imparting material can also be immobilized on the surface of the polymer matrix. FIGS. 7A to 7E show some examples of such cases. FIG. 7A shows an example based on adhesion in which the ammonium nitrate grains 10 and aluminum hydroxide grains 39 are immobilized on the surface of a polymer matrix 50 as being interposed by an adhesive resin layer 560 formed thereon. It is also allowable that the ammonium nitrate grains 10 and aluminum hydroxide grains 39 are further dispersed into the polymer matrix 50 (the same will apply also to the examples described hereinafter). Or as shown in FIG. 7B, such immobilized ammonium nitrate grains 10 and aluminum hydroxide grains 39 may further be covered with an overcoat 561 comprising a resin or the like.

FIG. 7C shows an example in which the coated ammonium nitrate grains 10 and aluminum hydroxide grains 39 are integrated with the surface of the matrix 50 composing a molded product 536, which is obtained by preliminarily coating the ammonium nitrate grains 10 and aluminum hydroxide grains 39 on the inner surface of a cavity of the die 505, and filling such die with a molten resin 570, which is then allowed to cure. FIG. 7D shows an example in which the ammonium nitrate grains 10 and aluminum hydroxide grains 39 are immobilized, which can be attained by preliminarily covering the surface of the ammonium nitrate grains 10 and aluminum hydroxide grains 39 with an immobilization resin layer 562, softening such immobilization resin layer 562 through heating so as to be adhered onto the surface of the matrix 50, and then curing the resin. In this case, preheating of the matrix 50 to a degree not causative of unnecessary deformation thereof will facilitate the softening and adhesion of the immobilization resin layer 562. FIG. 7E shows an example in which the ammonium nitrate grains 10 and aluminum hydroxide grains 39 are embedded into the surface portion of the matrix 50, which can be attained by blasting or pressurizing the ammonium nitrate grains 10 and aluminum hydroxide grains 39 onto the matrix 50. In this case, softening of at least the surface portion of the matrix 50 will facilitate such embedding.

In the present invention, the polymer material or polymer component composing the matrix is preferably selected from those mainly containing saturated hydrocarbon group, which are exemplified as polyethylene, polypropylene, ethylene-vinyl acetate copolymer, ethylene-vinyl alcohol copolymer and ethylene-polypropylene-diene copolymer (EPDM). Addition of the flame-retardancy-imparting material of the present invention into a polymer material mainly containing unsaturated hydrocarbon groups such as aromatic ring may be successful in providing flame retardancy but only in a limited degree as compared with the case it was added to a polymer material mainly containing saturated hydrocarbon groups, since oxidative decomposition of such polymer material cannot proceed smoothly due to the unsaturated hydrocarbon groups.

### EXPERIMENTAL EXAMPLE 1

The flame-retardancy-imparting material of the present invention was subjected to the following experiments.

15 g of ammonium nitrate, 150 g of aluminum hydroxide and 300 g of polypropylene resin (PP) were mixed, and the obtained mixture was made into a polymer molded product (sample 1) using an extrusion/injection molding machine. Independently, 60 g of ammonium nitrate, 210 g of aluminum hydroxide and 300 g of polyethylene resin (PE) were mixed, and the obtained mixture was made into a polymer molded product (sample 2) using an extrusion/injection molding machine. Still independently, ammonium nitrate grain preliminarily subjected to SiO₂ coating by the sol-gel process as shown in FIGS. 2A to 2C was compounded according to a compounding ratio same as that for the foregoing sample 1, and a polymer molded product (sample 3) was obtained using an extrusion/injection molding machine. The ammonium nitrate grain was also treated with stearic acid, and a polymer molded product (sample 4) was obtained similarly to the foregoing sample 1.

Thus obtained samples 1 to 4 were tested by Determination of Burning Behavior by Oxygen Index (JIS K-7201), UL94 combustibility test (fifth edition, Oct. 26, 1996), moldability (judged as good if no oily bloom observed), coloring of resin (visual inspection) and tensile strength (JIS K-7113). Results were shown in Table 1.

TABLE 1

| Sample No. | 1 | 2 | 3 | 4 |
|---|---|---|---|---|
| Resin | PP | PE | PP | PP |
| Surface treatment | none | none | SiO₂ coating | stearic acid |
| for NH₄NO₃ | | | by sol-gel | treatment |
| | | | process | |
| NH₄NO₃/Al(OH)₃/ | 5/50/100 | 20/70/100 | 5/50/100 | 5/50/100 |
| resin [parts by | | | | |
| weight] | | | | |
| OI [—] | 28.1 | 24.6 | 28.1 | 27.3 |
| Evaluation by UL94 | V-2 | V-2 | V-2 | V-2 |
| Extinction time (1st) | 7 sec | 0 sec | 5 sec | 8 sec |
| Extinction time | 6 sec | 2 sec | 4 sec | 7 sec |
| (2nd) | | | | |
| Moldability | good | good | good | good |
| Coloring of resin | none | none | none | none |
| Tensile strength | 20.6 | 12.2 | 21.5 | 21.3 |
| [MPa] | | | | |

All samples showed good results both in the oxygen index test and UL 94 test, which proved sufficient flame retardancy. Also the moldability was found to be desirable in all samples. No sample showed coloring of the resin. Samples 3 and 4, having the ammonium nitrate grain coated with SiO₂ by the sol-gel process and with stearic acid, respectively, showed higher tensile strength as compared with that shown by samples 1 and 2. Also samples using ammonium nitrite in place of ammonium nitrate gave almost similar good results in the same test.

Next, sample 1a which is similar to sample 1 except that containing no ammonium nitrate, and sample 1b which is similar to sample 1 except that containing zinc nitrate in place of ammonium nitrate were similarly tested and compared with sample 1. Results were shown in Table 2.

TABLE 2

| Sample No. | 1 | 1a | 1b |
|---|---|---|---|
| Resin | PP | PP | PP |
| Nitric acid compound | NH₄NO₃ | none | Zn(NO₃)₂ |
| Nitric acid compound/ | 5/50/100 | 0/50/100 | 5/50/100 |
| Al(OH)₃/resin | | | |
| [parts by weight] | | | |
| OI [—] | 28.1 | 22.4 | 28.1 |
| Evaluation by UL94 | V-2 | no effect | V-2 |
| Extinction time (1st) | 7 sec | ≧60 sec | 8 sec |
| Extinction time (2nd) | 6 sec | — | 6 sec |
| Moldability | good | good | good |
| Coloring of resin | none | none | slight |
| Tensile strength [MPa] | 20.6 | 21.4 | 17.2 |

Sample 1a containing no ammonium nitrate showed almost no flame-retardant effect, and sample 1b containing zinc nitrate in place of ammonium nitrate showed an almost equivalent level of flame retardancy with sample 1 but resulted in slight coloring of the resin. It is to be noted that addition of aluminum hydroxide and ammonium nitrate to the resin can produce white color ascribable to aluminum hydroxide. Such resin allows arbitrary coloring thereafter.

Next, sample 2a which is similar to sample 2 except that containing no ammonium nitrate, and sample 2b which is similar to sample 2 except that containing zinc nitrate in place of ammonium nitrate were similarly tested and compared with sample 2. Results were shown in Table 3.

TABLE 3

| Sample No. | 2 | 2a | 2b |
|---|---|---|---|
| Resin | PE | PE | PE |
| Nitric acid compound | NH₄NO₃ | none | Zn(NO₃)₂ |
| Nitric acid compound/ | 20/70/100 | 0/70/100 | 5/70/100 |
| Al(OH)₃/resin | | | |
| [parts by weight] | | | |
| OI [—] | 24.6 | 21.9 | 26.3 |
| Evaluation by UL94 | V-2 | no effect | V-2 |
| Extinction time (1st) | 0 sec | ≧60 sec | 0 sec |
| Extinction time (2nd) | 2 sec | — | 3 sec |
| Moldability | good | good | good |
| Coloring of resin | none | none | slight |
| Tensile strength [MPa] | 12.2 | 12.8 | 10.8 |

Sample 2a containing no ammonium nitrate showed almost no flame-retardant effect, and sample 2b containing zinc nitrate in place of ammonium nitrate showed an almost equivalent level of flame retardancy with sample 2 but resulted in slight coloring of the resin.

Moreover, sample 5 which is similar to sample 1 except that containing guanidine nitrate in place of ammonium nitrate, sample 6 which is similar to sample 1 except that containing magnesium hydroxide in place of aluminum hydroxide, and sample 7 which is similar to sample 6 except that containing guanidine nitrate in place of ammonium nitrate were similarly tested and compared with sample 1. Results were shown in Table 4.

TABLE 4

| Sample No. | 1 | 5 | 6 | 7 |
|---|---|---|---|---|
| Resin | PP | PP | PP | PP |
| Nitric acid compound | NH₄NO₃ | guanidine | NH₄NO₃ | guanidine |
| (x) | | nitrate | | nitrate |
| Metal hydroxide (y) | Al(OH)₃ | Al(OH)₃ | Mg(OH)₂ | Mg(OH)₂ |
| x/y/resin | 5/50/100 | 5/50/100 | 5/50/100 | 5/50/100 |
| [parts by weight] | | | | |
| OI [—] | 28.1 | 28.5 | 28.5 | 28.1 |
| Evaluation by UL94 | V-2 | V-2 | V-2 | V-2 |
| Extinction time (1st) | 7 sec | 8 sec | 7 sec | 7 sec |
| Extinction time (2nd) | 6 sec | 6 sec | 7 sec | 8 sec |
| Moldability | good | good | good | good |
| Coloring of resin | none | none | none | none |
| Tensile strength [MPa] | 20.6 | 20.7 | 20.2 | 20.6 |

Samples 1 and 5 to 7 were found to have excellent flame retardancy, and cause no coloring of the resin. It is thus known from the findings that the polymer material, which is obtained by blending a polymer component (target object) such as resin with the flame-retardancy-imparting material containing a group expressed by NₓO_{y} (where, x and y are positive integers) (e.g., ammonium nitrate, ammonium nitrite, guanidine nitrate, zinc nitrate) and a group capable of generating water, exhibits excellent flame retardancy while successfully keeping properties of the resin before such compounding almost intact.

### EXPERIMENTAL EXAMPLE 2

The flame-retardancy-imparting material of the present invention was further subjected to the following experiments.

The individual nitric acid compounds as the nitrogen compound, and the individual hydroxyl-group-containing compounds, both of which being listed in Table 5, were mixed with any of the target objects which are exemplified as polypropylene (PP: product of Grand Polymer Co., Ltd., J708), polyethylene (PE: product of Japan Polychem Corporation, LJ800) and ethylene-vinyl acetate copolymer (EVA: product of Tosoh Corporation, U-537), and polymer molded products were obtained using an extrusion/injection molding machine (Examples 1 to 10). The obtained molded products were tested according to Determination of Burning Behavior by Oxygen Index (JIS K-7201) and UL94 combustibility test (fifth edition, Oct. 26, 1996). Results were shown in Table 5. Decomposition temperature of the individual compounds measured in the thermal analyses were shown in Tables 6 and 7.

TABLE 5

| | | Hydroxyl- | | | |
|---|---|---|---|---|---|
| | | group- | | | |
| | Nitric acid | containing | Resin | | |
| | compound | compound | [parts | | |
| | [parts by | [parts | by | | |
| | weight] | by weight] | weight] | OI | UL94 |
| Example 1 | Zn(NO₃)₂ [7.5] | Al(OH)₃ [50] | PP [100] | 30.7 | V-2 |
| Example 2 | Zn(NO₃)₂ [10] | Al(OH)₃ [50] | PE [100] | 27.8 | V-2 |
| Example 3 | Zn(NO₃)₂ [10] | Al(OH)₃ [50] | EVA | 28.9 | V-2 |
| | | | [100] | | |
| Example 4 | Ni(NO₃)₂ [7.5] | Al(OH)₃ [50] | PP [100] | 30.7 | V-2 |
| Example 5 | Cu(NO₃)₂ [7.5] | Al(OH)₃ [50] | PP [100] | 27.2 | V-2 |
| Example 6 | NH₄NO₃ [5] | Al(OH)₃ [50] | PP [100] | 29.8 | V-2 |
| Example 7 | (NH₄)₂Ce(NO₃)₄ | Al(OH)₃ [50] | PP [100] | 28.9 | V-2 |
| | [7.5] | | | | |
| Example 8 | Zn(NO₃)₂ [30] | Mg(OH)₂ [70] | PP [100] | 21.1 | — |
| Example 9 | LiNO₃ [10] | Al(OH)₃ [50] | PP [100] | 20.5 | — |
| Example | KNO₃ [10] | Al(OH)₃ [50] | PP [100] | 20.5 | — |
| 10 | | | | | |

TABLE 6

| | | Dehydration | | | |
|---|---|---|---|---|---|
| | Melting | temperature | Decomposition | | |
| | point | (crystal | temperature | | |
| | (° C.) | water) (° C.) | (° C.) | | UL94 |
| Zn(NO₃)₂.6H₂O | 39 | 101 | 204 | 338 | V-2 |
| Ni(NO₃)₂.6H₂O | 75 | 177 | 248 | 306 | V-2 |
| Cu(NO₃)₂.6H₂O | 119 | 148 | 236 | 249 | V-2 |
| LiNO₃ | 255 | — | 676 | 690 | — |
| KNO₃ | 334 | — | (none up to 500° C.) | | — |
| KNO₂ | 429 | — | (none up to 500° C.) | | — |
| NaNO₃ | 306 | — | (none up to 500° C.) | | — |
| NaNO₂ | 281 | — | (none up to 500° C.) | | — |
| NH₄NO₃ | 169 | — | 286 | — | V-2 |

TABLE 7

| | Decomposition | |
|---|---|---|
| | initiation | Decomposition |
| | temperature (° C.) | temperature (° C.) |
| Untreated Zn(NO₃)₂ | ≦70 | 101, 204, 338 |
| Dried Zn(NO₃)₂ | 204 | 230, 279 |
| Untreated Cu(NO₃)₂ | ≦70 | 31, 148, 236, 249 |
| Dried Cu(NO₃)₂ | 226 | 246 |
| Untreated Ni(NO₃)₂ | ≦70 | 63, 177, 248, 306 |
| Dried Ni(NO₃)₂ | 194 | 226, 286 |

Decomposition temperature of dry preparations of the individual compound was measured as 204° C. for zinc nitrate, 248° C. for nickel nitrate, 236° C. for copper nitrate, 286° C. for ammonium nitrate, 500° C. or above for lithium nitrate and potassium nitrate, approx. 300° C. for aluminum hydroxide and approx. 350° C. for magnesium hydroxide. The individual molded products obtained in Examples 1 to 7 gave good results in the oxygen index (OI) test and UL94 test, which proves sufficient flame retardancy. It was also confirmed that the individual molded products obtained in Examples 1 to 7 can ensure a desirable degree of flame retardancy in an amount of addition of as low as 55 to 60 parts by weight per 100 parts by weight of the resin, where the nitric acid compound accounts for 5 to 10 parts by weight, and the hydroxyl-group-containing compound accounts for 50 parts by weight. All molded products obtained in Examples 1 to 7 were found to be excellent in the moldability. On the other hand, all molded products obtained in Examples 8 to 10, in which decomposition temperatures largely differ between the nitric acid compound and hydroxyl-group-containing compound, showed flame retardancy only to a degree smaller than that shown in Examples 1 to 7.

Findings of the thermal analyses listed in Table 7 proved advantage of drying treatment (alcohol dehydration) of the nitric acid compound. Metal nitrate without drying treatment will start to decompose at a temperature at approx. 70° C. or lower, which undesirably reduces a ratio of such metal nitrate decomposable at the decomposition temperature of the hydroxyl-group-containing compound, which results in only a limited degree of flame retardancy. So that the decomposition temperature of the metal nitrate as close as possible to that of the hydroxyl-group-containing compound will give better results. Such condition ensures most efficient production of nitric acid through reaction between a nitrogen compound and water generated by the decomposition. Thus produced nitric acid eventually allows rapid progress of thermal decomposition of the polymer. Care should be taken since the decomposition of the metal nitrate in an excessively low temperature range may degrade the intrinsic moldability or various properties of the polymer material due to generated nitrogen oxide. The thermal analysis herein was performed using a thermogravimetric differential thermal analyzer (TG-DTA) apparatus manufactured by Rigaku International Corporation, at a temperature elevation rate of 10° C./min. The same condition for the temperature elevation in the DTA measurement was applied also to the experiments thereafter.

Next, the molded product of Example 1 listed in Table 5, the molded product of Example 11 listed in Table 8, which product contains the same components as in Example 1 and wherein the nitric acid compound is coated with SiO₂ by the foregoing sol-gel process, and a polypropylene molded product (Comparative Example 1) were subjected to tensile strength test, elongation test, Izod impact test, and combustion test based on oxygen index. Results were shown in Table 8.

TABLE 8

| | Zn(NO₃)₂/ | | | | | |
|---|---|---|---|---|---|---|
| | Al(OH)₃/ | | | | | |
| | PP [parts | Surface | Tensile | Elongation | | |
| | by weight] | treatment | strength | percentage | Izod | OI |
| Example 1 | 7.5/50/100 | none | 23.6 | 8 | 4.1 | 30.7 |
| Example 11 | 7.5/50/100 | SiO₂ | 21.4 | 13 | 5.2 | 29.8 |
| | | coated | | | | |
| | | Zn(NO₃)₂ | | | | |
| Comparative | 0/0/100 | none | 27.7 | >200 | 5.8 | 17.5 |
| example 1 | | | | | | |

As for mechanical properties such as tensile strength (in Pa), elongation percentage (in %) and Izod impact value (in J/m²), Examples 1 and 11 were found to be lowered in the elongation percentage as compared with Comparative Example 1, but no considerable decrease in the tensile strength and impact strength were observed. In particular for Example 11 in which zinc nitrate is coated with SiO₂ by the sol-gel process gave better results in the elongation percentage and Izod impact value. The obtained oxygen indices indicated that desirable flame retardancy was attained both in Examples 1 and 11.

From these findings, the polymer material, which is obtained by blending a polymer component (target object) such as resin with the flame-retardancy-imparting material containing a group expressed by NₓO_{y} (where, x and y are positive integers) (e.g., ammonium nitrate, ammonium nitrite, guanidine nitrate, zinc nitrate) and a group capable of generating water, exhibits excellent flame retardancy while successfully keeping properties of the resin before such compounding almost intact.

Ammonium nitrate and aluminum hydroxide individually in the amounts shown in Table 9 below were mixed with 100 parts by weight of polypropylene resin, and the burning test (JISK-7201) by an oxygen index method and UL94 combustibility test were performed. According to these tests, sample 8 containing neither ammonium nitrate nor the aluminum hydroxide did not show flame retardancy. Samples 9 to 11 containing either one of ammonium nitrate and aluminum hydroxide were also burned and did not show flame retardancy. On the other hand, both of sample 12 having 5 parts by weight of ammonium nitrate and 50 parts by weight of aluminum hydroxide mixed with 100 parts by weight of the polypropylene resin, and sample 13 having 7 parts by weight of ammonium nitrate and 70 parts by weight of aluminum hydroxide mixed with 100 parts by weight of the polypropylene resin showed a high flame retardancy ranked at V2 in the UL94 combustibility test. From comparison among samples 9, 10 and 12, it was found that samples 9 and 10 containing only either one of ammonium nitrate and aluminum hydroxide did not show flame retardancy, but sample 12 containing both of ammonium nitrate and aluminum hydroxide showed a high flame retardancy, even under the amounts of addition of ammonium nitrate and aluminum hydroxide remained unchanged. It was confirmed from the above experiment that the combined addition of ammonium nitrate and aluminum hydroxide can provide an excellent flame retardancy even in a small amount of addition thereof.

TABLE 9

| Sample No. | 8 | 9 | 10 | 11 | 12 | 13 |
|---|---|---|---|---|---|---|
| Resin | 100 | 100 | 100 | 100 | 100 | 100 |
| (parts by weight) | | | | | | |
| NH₄NO₃ | 0 | 5 | 0 | 0 | 5 | 7 |
| (parts by weight) | | | | | | |
| Al(OH)₃ | 0 | 0 | 50 | 100 | 50 | 70 |
| (parts by weight) | | | | | | |
| OI(—) | 18.9 | 18.9 | 21.1 | 23.2 | 33.3 | 36.0 |
| Evaluation | burned | burned | burned | burned | V2 | V2 |
| by UL94 | | | | | | |

More specifically, an approach of imparting a sufficient level of flame retardancy through addition only of aluminum hydroxide to the resin will be successful only when aluminum hydroxide is blended in an amount of 150 parts by weight or more per 100 parts by weight of the resin. On the contrary, the combined addition of aluminum hydroxide and ammonium nitrate to the resin makes it possible to achieve a sufficient level of flame retardancy and to sharply decrease the overall amount of mixing to the resin, such as being typified by a total amount of aluminum hydroxide and ammonium nitrate of 55 parts by weight (sample 12) and 77 parts by weight (sample 13), per 100 parts by weight of the resin. In other words, a sufficient level of flame retardancy is obtainable through the combined addition of aluminum hydroxide and ammonium nitrate, even under such small amount of mixing of the flame retarder to the resin.

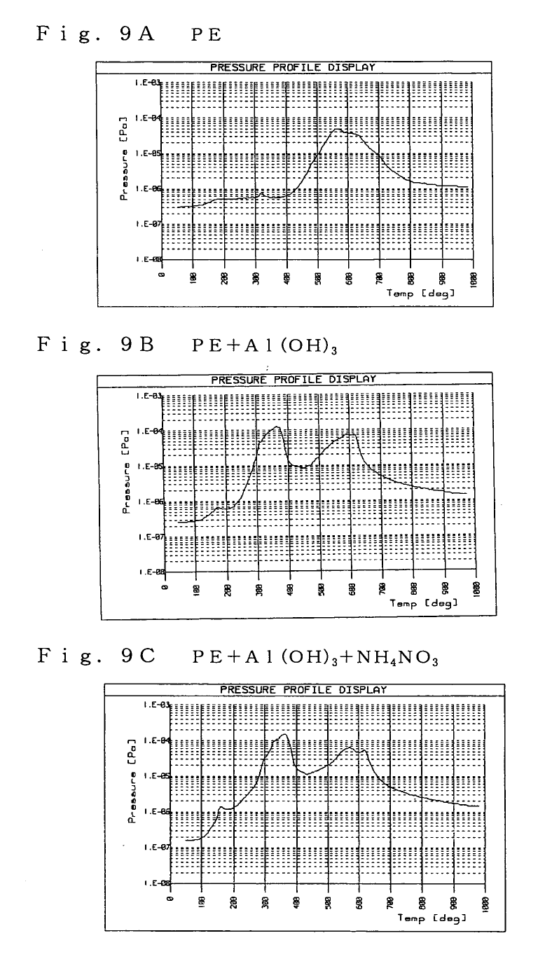

The following measurements were carried out to elucidate the exhibition mechanism of the flame retardancy in the flame-retardancy-imparting material of the present invention. First, gases emitted during the temperature elevation were examined by TDS (thermal desorption spectroscopy) measurement. In the measurement, the individual samples were heated by infrared radiation at a speed of 50° C./min using a thermal desorption analyzer manufactured by Denshi Kagaku K.K. (the same will apply to all TDS analyses thereafter). At the same time, the emitted gases were also examined by mass spectroscopy (abbreviated as MS, hereinafter) Three samples were used herein, which were simple polyethylene (PE) also used in the foregoing Experiment, a composition containing such polyethylene and aluminum hydroxide (PE+Al(OH)₃), and a composition containing such composition and ammonium nitrate (PE+Al(OH)₃+NH₄NO₃). Results were expressed as graphs in FIGS. 9A to 9C. In the individual graphs, the abscissa denotes temperature and the ordinate denotes pressure. In FIG. 9A, a large pressure change observed at around 550 to 600° C. is ascribable to generation of hydrocarbons caused by the decomposition of polyethylene, which can be seen also in the systems of (PE+Al(OH)₃) and (PE+Al(OH)₃+NH₄NO₃). On the other hand, the binary (PE+Al(OH)₃) system and ternary (PE+Al(OH)₃+NH₄NO₃) system showed a pressure change at around 350° C., which is not observed for the unitary. (PE) system. From this, it can be concluded that the systems of (PE+Al(OH)₃) and (PE+Al(OH)₃+NH₄NO₃) cause emission of the gases (e.g., H₂O gas in conjunction with the decomposition of Al(OH)₃) almost at the same temperature.

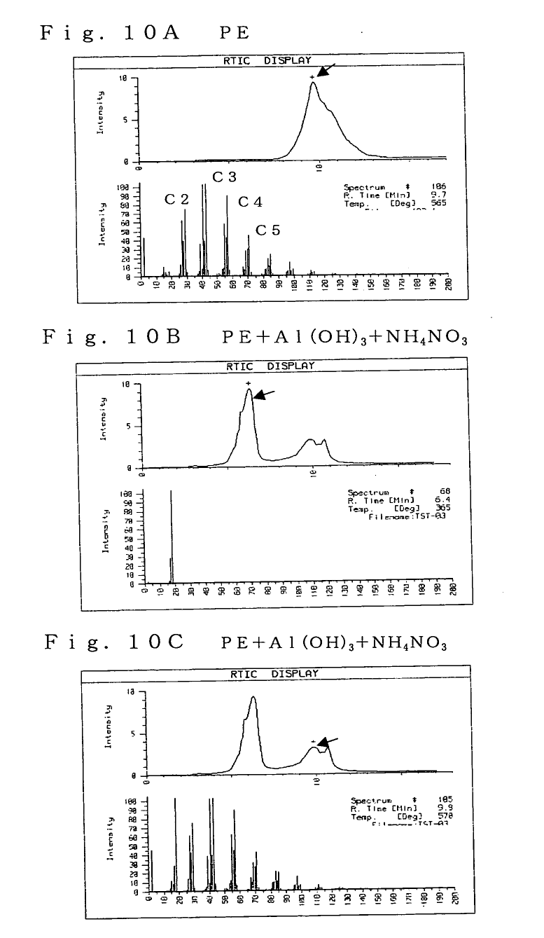

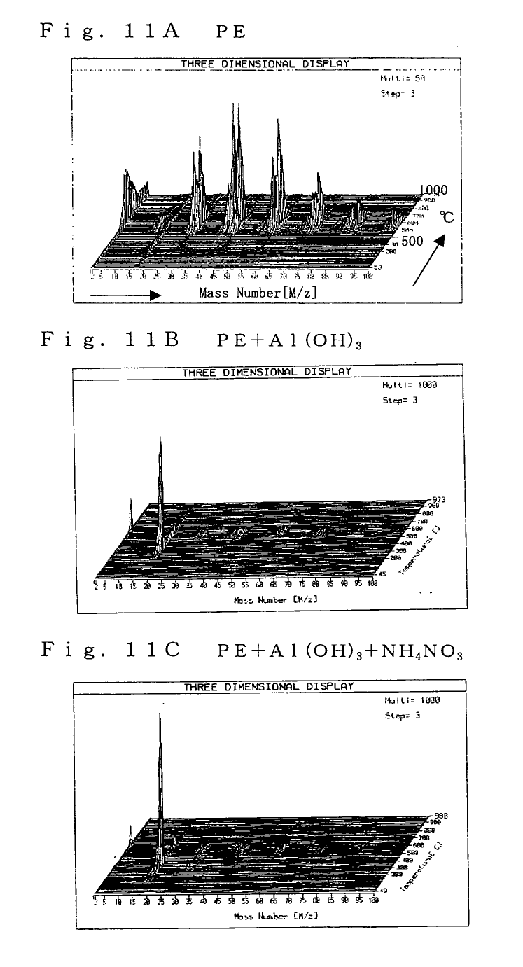

Next, the ternary (PE+Al(OH)₃+NH₄NO₃) system was examined by MS at a predetermined temperature. Results were shown in FIGS. 10B and 10C. In these graphs, the abscissa denotes mass number (m/z) and the ordinate denotes spectral intensity. FIG. 10A comparatively shows a mass spectrum for the unitary (PE) system measured at 565° C., FIG. 10B shows a mass spectrum for the ternary (PE+Al(OH)₃+NH₄NO₃) system measured at 365° C. (low temperature side), and FIG. 10C shows a mass spectrum for the ternary (PE+Al(OH)₃+NH₄NO₃) system measured at 570° C. (high temperature side). From these results, the ternary (PE+Al(OH)₃+NH₄NO₃) system generates H₂O in the low temperature side (approx. 300 to 400° C.), and generates hydrocarbons in conjunction with the decomposition of polyethylene in the high temperature side (approx. 550 to 600° C.). FIGS. 11A to 11C are three-dimensional MS charts, in which an additional dimension (Z axis) denotes temperature. Note that all temperatures described in this specification and the attached drawings are expressed in ° C.

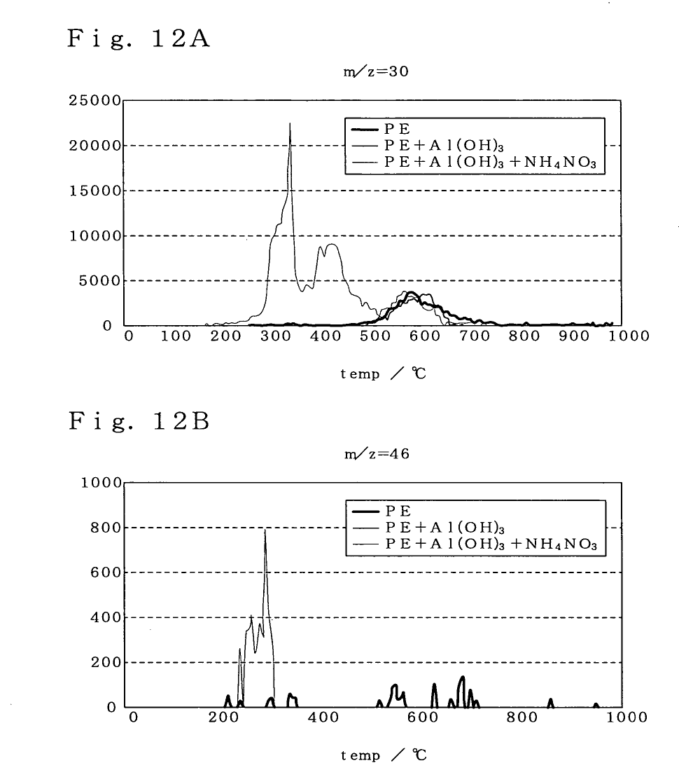

Next, to analyze generation conditions specific to m/z=30 (NO) and m/z=46 (NO₂), each of polyethylene (PE), the composition of polyethylene and aluminum hydroxide (PE+Al(OH)₃), and the composition of polyethylene and aluminum hydroxide and ammonium nitrate (PE+Al(OH)₃+NH₄NO₃) was examined for the amount of generation of m/z=30 (NO) and m/z=46 (NO₂) at the individual temperatures. FIGS. 12A and 12B show the obtained analytical graphs. FIG. 12A indicates that only the (PE+Al(OH)₃+NH₄NO₃) system is responsible for the generation of m/z=30 (NO) at around 300° C. and 400° C. FIG. 12B indicates that only the (PE+Al(OH)₃+NH₄NO₃) system is responsible for the generation of m/z=46 (NO₂) at around 250 to 300° C. It was thus known that a system containing aluminum hydroxide and ammonium nitrate, in particular a resin (PE) containing such two components, can generate m/z=30 (NO) and m/z=46 (NO₂) before the resin starts to decompose (500 to 700° C.).

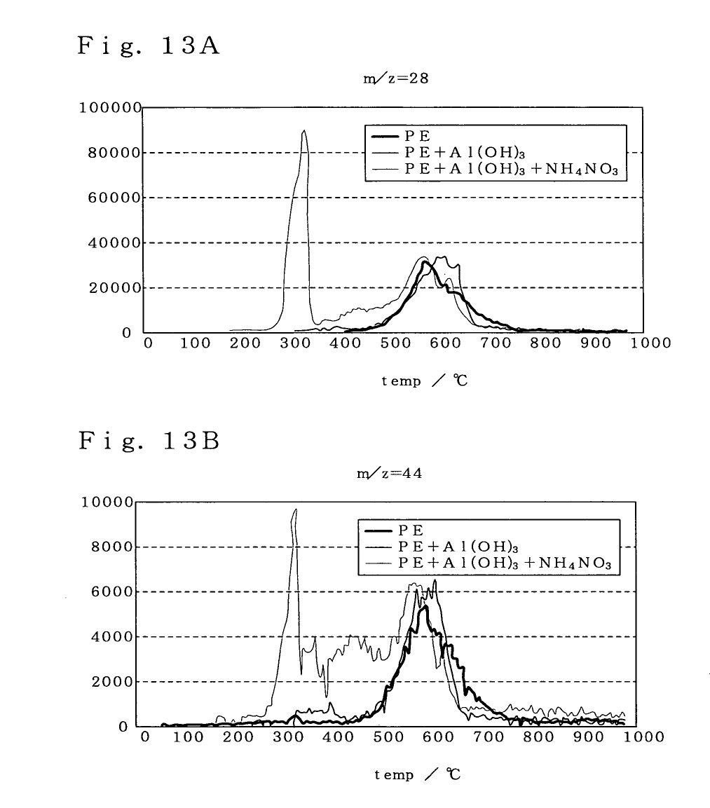

Similarly, to analyze generation conditions specific to m/z=28 (CO) and m/z=44 (CO₂), the individual systems of (PE), (PE+Al(OH)₃) and (PE+Al(OH)₃+NH₄NO₃) were examined for the amount of generation of m/z=28 (CO) and m/z=44 (CO₂). FIGS. 13A and 13B show the obtained analytical graphs. It was known from FIGS. 13A and 13B that only the (PE+Al(OH)₃+NH₄NO₃) system is responsible for the generation of m/z=28 (CO) and m/z=44 (CO₂) at around 300° C. It was thus known that a system containing aluminum hydroxide and ammonium nitrate, in particular a resin (PE) containing such two components, can generate m/z=28 (CO) and m/z=44 (CO₂) before the resin starts to decompose (500 to 700° C.). It should now be noted that m/z=44 may represents N₂O.

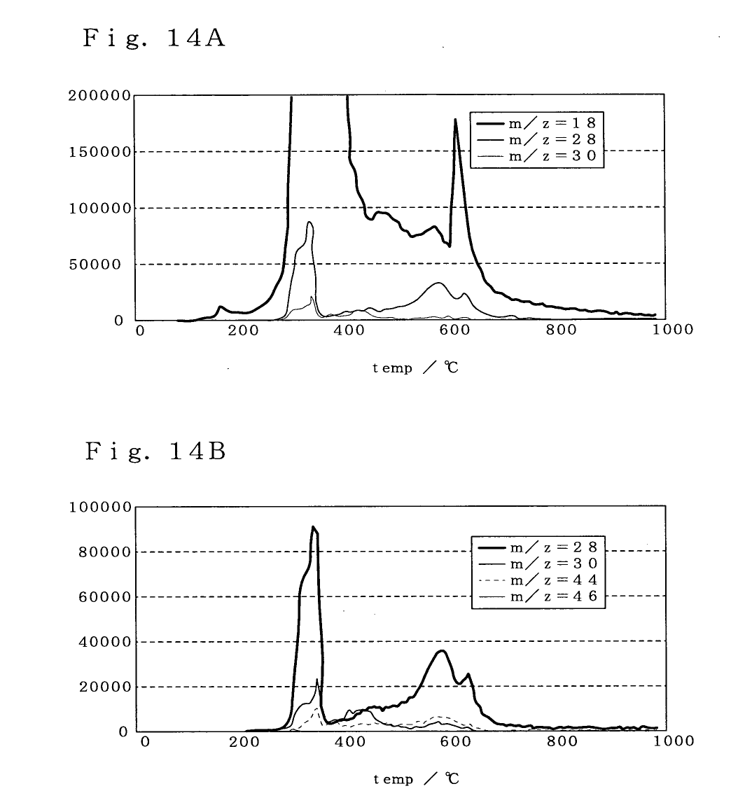

To further analyze generation conditions specific to m/z=18 (H₂O), m/z=28 (CO), m/z=30 (NO), m/z=44 (CO₂) and m/z=46 (NO₂), the composition of polyethylene and aluminum hydroxide and ammonium nitrate (PE+Al(OH)₃+NH₄NO₃) was examined for the amount of generation of such individual gases. FIGS. 14A and 14B show the obtained analytical graphs. The abscissa denotes temperature and the ordinate denotes spectral intensity. It was known from FIGS. 14A and 14B that m/z=18 (H₂O), m/z=28 (CO), m/z=30 (NO), m/z=44 (CO₂) and m/z=46 (NO₂) were found to generate at around 300 to 350° C. almost at the same time. It was thus known that a system containing the composition comprising polyethylene and aluminum hydroxide and ammonium nitrate can generate m/z=18 (H₂O), m/z=28 (CO), m/z=30 (NO), m/z=44 (CO₂) and m/z=46 (NO₂) almost at the same time before the resin starts to decompose (500 to 700° C.). It should now be noted that m/z=44 may represents N₂O. It is to be noted that NO₂ generates only in a small amount and is thus difficult to be confirmed on the spectral basis.

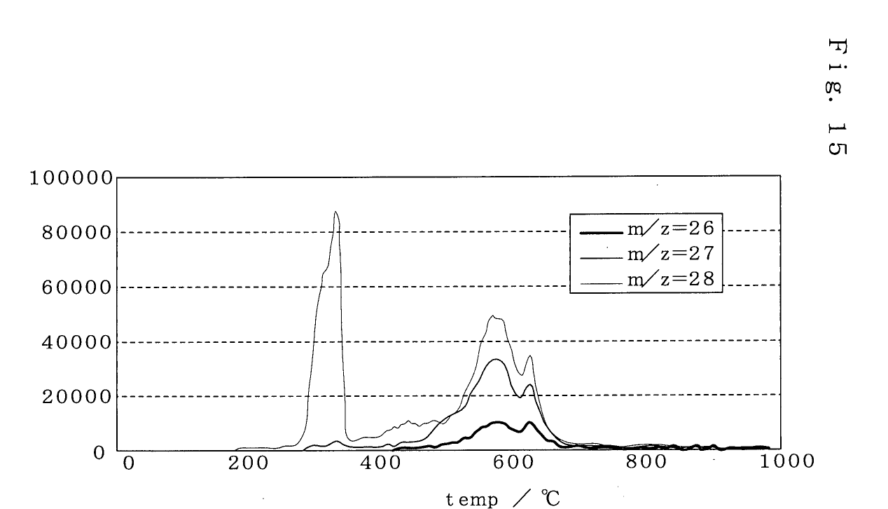

Next, to identify gas component of m/z=28 generated at around 300° C., components ascribable to m/z=26 to 28 of the (PE+Al(OH)₃+NH₄NO₃) system were examined by the TDS measurement. FIG. 15 shows an obtained graph. The abscissa denotes temperature and the ordinate denotes spectral intensity. FIG. 15 suggested that m/z=28 observed at around 300° C. is not ascribable at least to C₂H₄, but to CO in consideration of the constituents and the fact that neither m/z=26 nor 27 (corresponded to C₂H₂ and C₂H₃, respectively) was observed.

From these findings, the composition of polyethylene and aluminum hydroxide and ammonium nitrate (PE+Al(OH)₃+NH₄NO₃) can sharply emit CO and CO₂ at around 300 to 350° C., which suggests that oxidative decomposition of polyethylene can proceed before the combustion (500 to 700° C.) occurs. Since H₂O, NO and NO₂ (also N₂O may be included) were found to generate almost at the same time with CO and CO₂, it is supposed that HNO₃ generated from H₂O, NO and NO₂ instantaneously decomposes polyethylene.

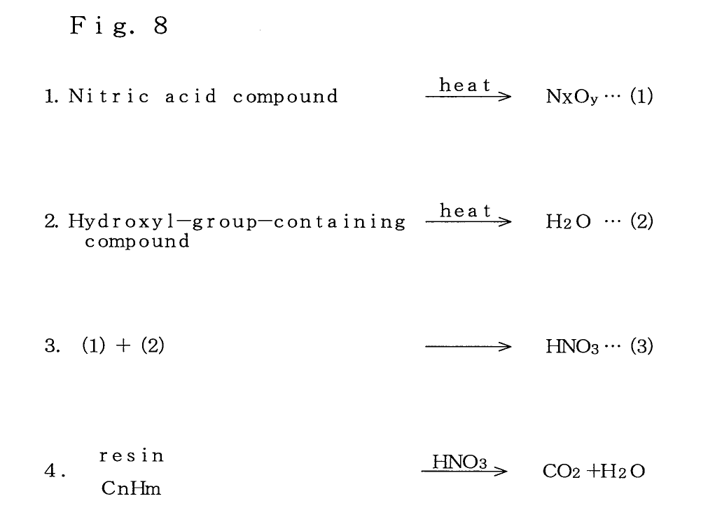

More specifically, as shown in FIG. 8, the nitric acid compound, which is one component of the combustion-inhibitory oxidative decomposition accelerator contained in the flame-retardancy-imparting material of the present invention, produces NₓO_{y} (1) upon heating. On the other hand, the hydroxyl-group-containing compound, which is another component of the combustion-inhibitory oxidative decomposition accelerator, generates H₂O (2). Such (1) and (2) generated upon heating react with each other to produce HNO₃, and which HNO₃ acts as an oxidant for oxidatively decomposing the resin (CₙHₘ). The oxidative decomposition is not accompanied by flame, and can proceed at a temperature lower than the combustion temperature of the resin. So that the flame-retardancy-imparting material of the present invention containing such combustion-inhibitory oxidative decomposition accelerator can exhibit flame retardancy. The temperature whereat HNO₃ generates depends on the decomposition temperature of the nitric acid compound and hydroxyl-group-containing compound. That is, temperature whereat the resin decomposes can be determined to some arbitrary degree by properly selecting combination of the nitric acid compound and hydroxyl-group-containing compound. Flame retardancy will successfully given to the resin only when a temperature whereat HNO₃ generates is set lower than the decomposition temperature of the resin. In other words, when the nitric acid compound and hydroxyl-group-containing compound are properly combined so as to ensure a decomposition temperature lower than the combustion temperature of the target resin and then added to the resin, such resin is oxidatively decomposed before it burns in flame. This is why the flame retardancy is attained. The hydroxyl-group-containing compound may contain crystal water, or can be replaced with a hydrated compound.

The next effort was directed to identify the decomposition products through TG-MS measurement. The gases emitted when the foregoing composition comprising polyethylene and aluminum hydroxide and ammonium nitrate (PE+Al(OH)₃+NH₄NO₃) was thermally decomposed in the TG-DTA apparatus were measured in situ by GC/MS measurement.

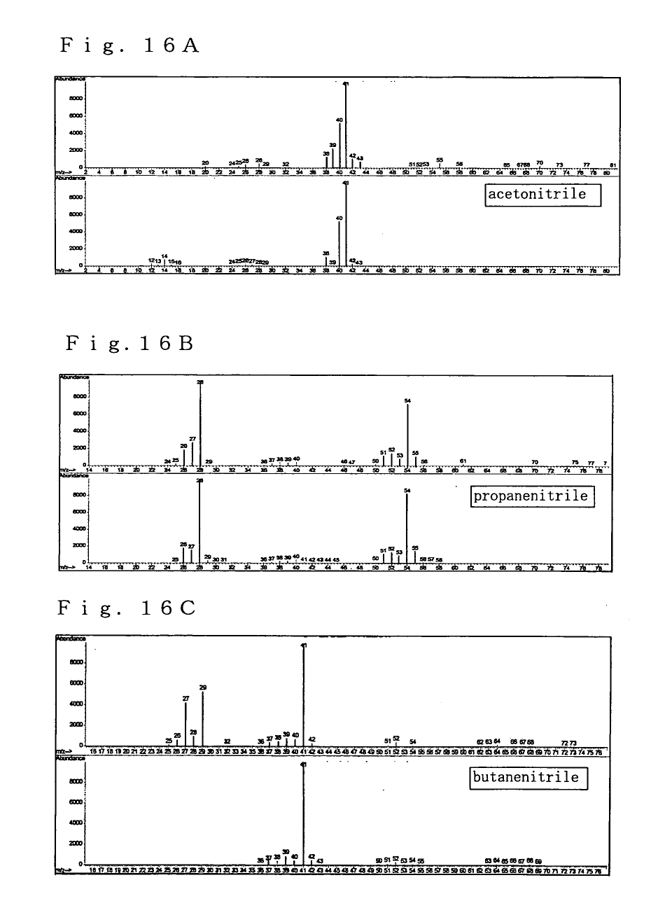

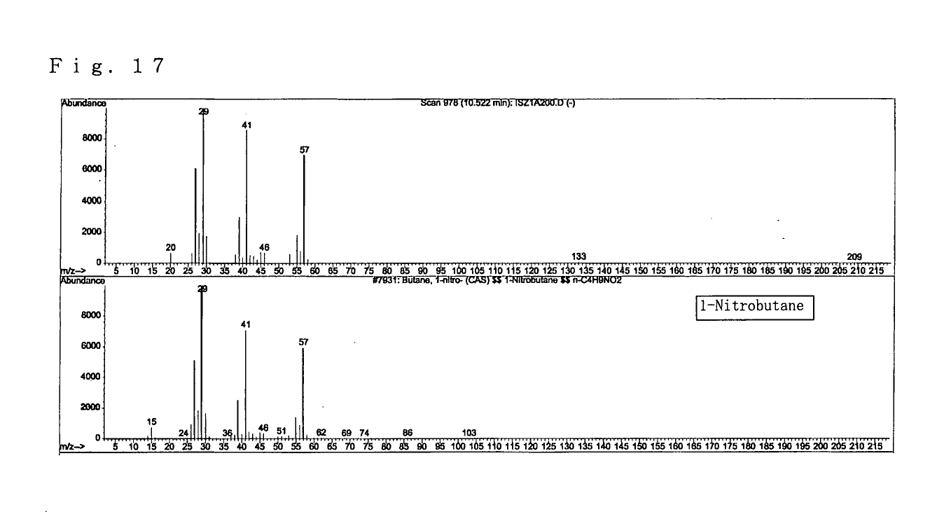

The first TG-MS measurement was carried out in a He atmosphere in order to identify the decomposition products generated at 300° C. Results were shown in FIGS. 16A to 16C. In each of FIGS. 16A to 16C, the upper chart shows a spectrum obtained from the actual measurement, and the lower chart shows a reference spectrum stored in a computer, which is used for comparison with the actual spectrum to thereby allow identification of the decomposition products. It was made clear from FIGS. 16A to 16C that the decomposition products generated when the ternary composition (PE+Al(OH)₃+NH₄NO₃) was heated at 300° C. include at least nitrile compounds, which are detailed as acetonitrile (FIG. 16A), propanenitrile (FIG. 16B) and butanenitrile (FIG. 16C). Similar TG-MS measurement in order to identify the decomposition products generated at 300° C. in an atmosphere containing 20% of O₂ (simulated air) revealed that, as shown in FIG. 17, the decomposition products include at least nitro compound, which is detailed as 1-nitrobutane. Also in FIG. 17, the upper chart shows an actually measured spectrum and the lower chart shows a reference spectrum, similarly to FIGS. 16A to 16C. Note that, in FIGS. 16A to 16C and 17, the abscissa denotes m/z and the ordinate denotes spectral intensity.

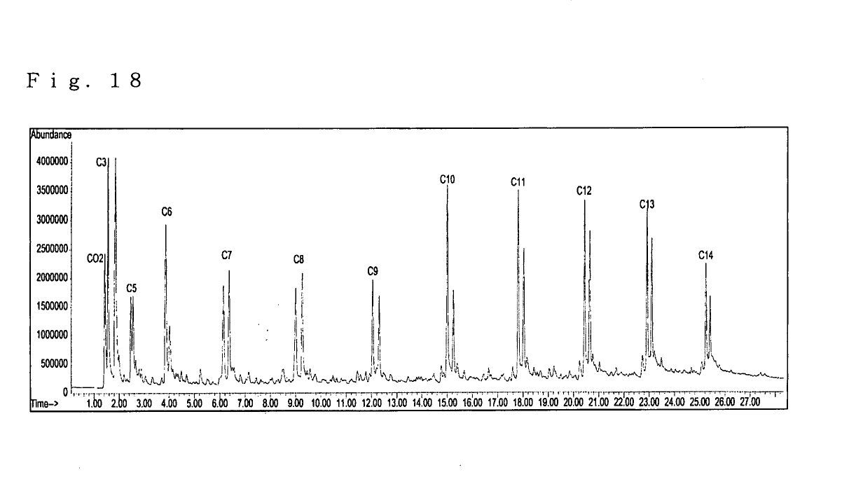

On the other hand, similar TG-MS measurement of the decomposition products generated at 480° C. revealed that, as shown in FIG. 18, the decomposition products mainly comprise hydrocarbons, which were found as similar to those contained in a decomposition peak of polyethylene observed at around 480° C. It was made clear from these results that the decomposition reaction occurs at around 300° C., whereat the nitrile and nitro compounds are generated from polyethylene, is absolutely different from the combustive degradation at around 480° C.

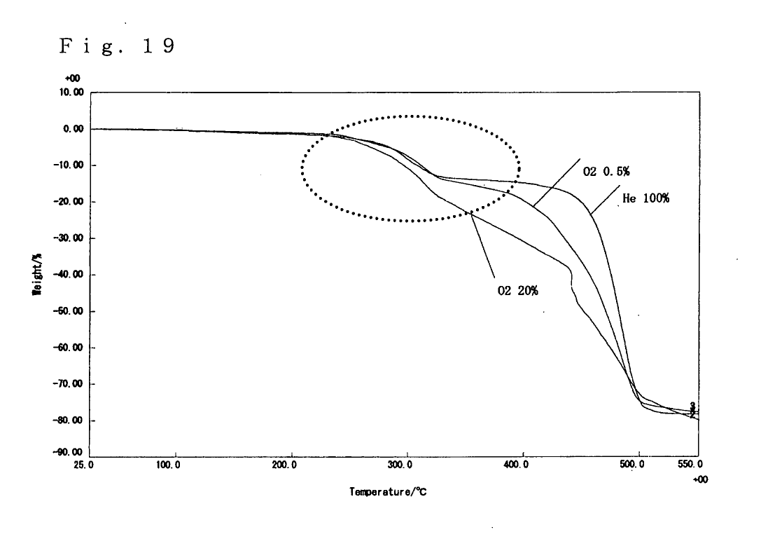

Weight changes during the temperature elevation were then measured individually in a He atmosphere and O₂ atmosphere. Results were shown in FIG. 19, where the abscissa denotes temperature and the ordinate denotes weight change. It was made clear that presence of O₂ accelerated weight reduction due to oxidative decomposition at around 250° C. and thereafter (which is referred to as combustion-inhibitory oxidative decomposition).

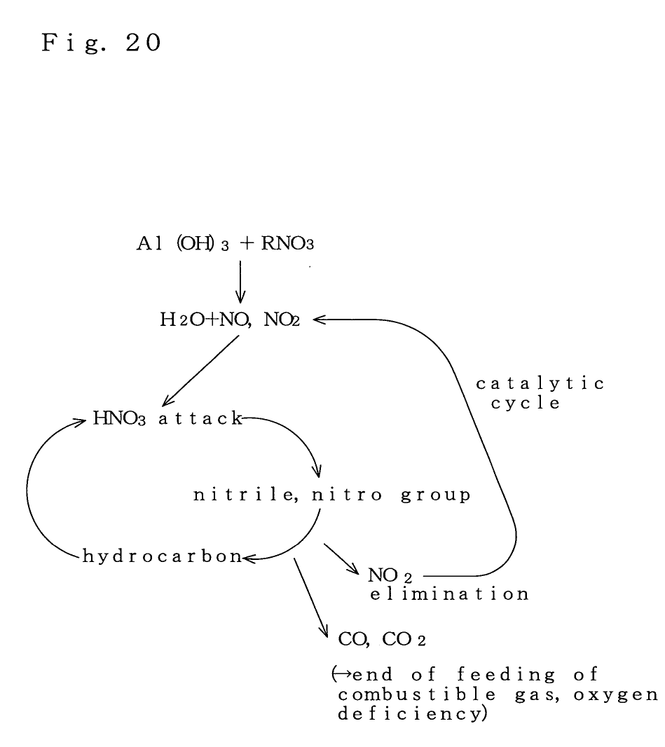

Based on the findings from the TDS and TG-MS measurements, the exhibition mechanism of the flame retardancy of the flame-retardancy-imparting material according to the present invention can be explained as follows. That is, as shown in FIG. 20, aluminum hydroxide and nitric acid compound (ammonium nitrate) decompose upon heating (at around 300° C.) to generate H₂O, NO and NO₂ (also N₂O may be contained), which products further react with each other to produce HNO₃. The resultant HNO₃ oxidatively decomposes the resin such as polyethylene to thereby exhibit the flame retardant effect. During such decomposition process, NO₂ is eliminated, and CO and CO₂ are produced. It is supposed that the eliminated NO₂ again reacts with H₂O released from aluminum hydroxide to produce HNO₃, which can be understood as a catalytic cycle. The flame-retardancy-imparting material of the present invention thus can exhibit a sufficient level of flame retardancy by adding a relatively small amount of nitric acid compound to aluminum hydroxide. More specifically, an excellent flame retardancy can be attained by adding approx. 1 to 50 parts by weight, and more preferably approx. 3 to 20 parts by weight of nitric acid compound to 100 parts by weight of aluminum hydroxide. Decomposition residues, which remained in a form of short-chain hydrocarbons without being degraded to as small as CO or CO₂, are supposed to be repetitively decomposed by the regenerated HNO₃ so as to finally produce CO and CO₂. The generation of CO or CO₂ will reduce supply of combustible gas (O₂) to thereby produce a combustion-inhibitory atmosphere, which is responsible for an excellent flame retardant effect.

Next, the experiment below was made for the purpose of confirming preferable ratio of weight between ammonium nitrate and aluminum hydroxide. First, aluminum hydroxide was grinded so as to adjust the average grain size thereof to 0.1 to 100 μm, and then subjected to surface treatment with a fatty-acid-base treatment agent. Next, ammonium nitrate was grinded so as to adjust the average grain size thereof to 0.01 to 100 μm, and then subjected to surface treatment with silica. Thus obtained aluminum hydroxide and ammonium nitrate were mixed in the amounts of mixing listed in Table 10 below with 100 parts by weight of polypropylene resin, to thereby obtain flame-retardant polymer materials. Measured values of oxygen index (OI) (based on JIS K-7201) of the individual samples and contents of ammonium nitrate per one part by weight of aluminum hydroxide (NH₄NO₃/Al(OH)₃) are shown in Table 10.

TABLE 10

| | | | | | | | | | | | |
|---|---|---|---|---|---|---|---|---|---|---|---|
| Al(OH)₃ | 30 | 30 | 30 | 30 | 50 | 50 | 50 | 50 | 70 | 70 | 70 |
| (parts by weight) | | | | | | | | | | | |
| NH₄NO₃ | 1.5 | 3 | 5 | 7 | 3 | 5 | 7 | 10 | 5 | 7 | 10.5 |
| (parts by weight) | | | | | | | | | | | |
| NH₄NO₃/Al(OH)₃ | 0.05 | 0.10 | 0.17 | 0.23 | 0.06 | 0.10 | 0.14 | 0.20 | 0.07 | 0.10 | 0.15 |
| Resin | 100 | 100 | 100 | 100 | 100 | 100 | 100 | 100 | 100 | 100 | 100 |
| (parts by weight) | | | | | | | | | | | |
| OI(—) | 21.0 | 27.0 | 27.7 | 28.1 | 27.2 | 33.3 | 34.2 | 34.2 | 30.7 | 36.0 | 36.0 |

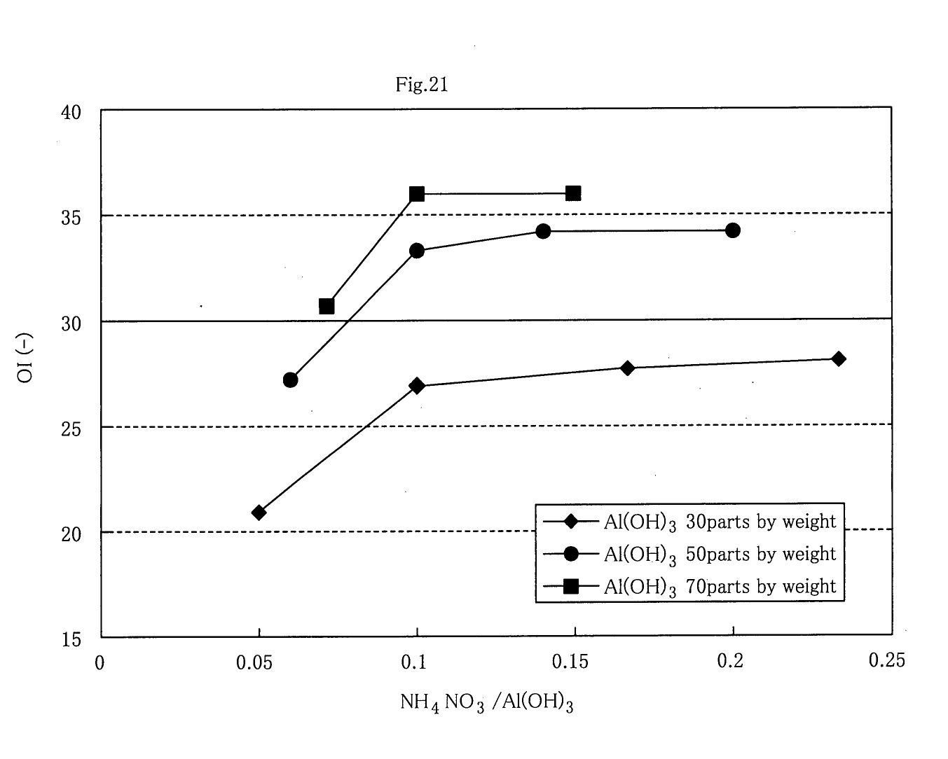

A graph (FIG. 21) showing relations between NH₄NO₃/Al(OH)₃ and oxygen index (OI) was prepared referring to Table 10. It is confirmed from the graph that the oxygen index increased (flame retardancy improves) as the amount of addition of aluminum hydroxide increased from 30 through 50 to 70 parts by weight. It was also confirmed that the oxygen index OI increased within a range of NH₄NO₃/Al(OH)₃ of 0.05 to 0.1, but saturated in the range from 0.1 to 0.2. It was known from the fact that the content of ammonium nitrate per one part by weight of aluminum hydroxide (NH₄NO₃/Al(OH)₃) less than 0.05 was not always successful in achieving a sufficient level of flame retardancy, and that the content exceeding 0.2 was not so effective against expectation as judged from the amount of addition.

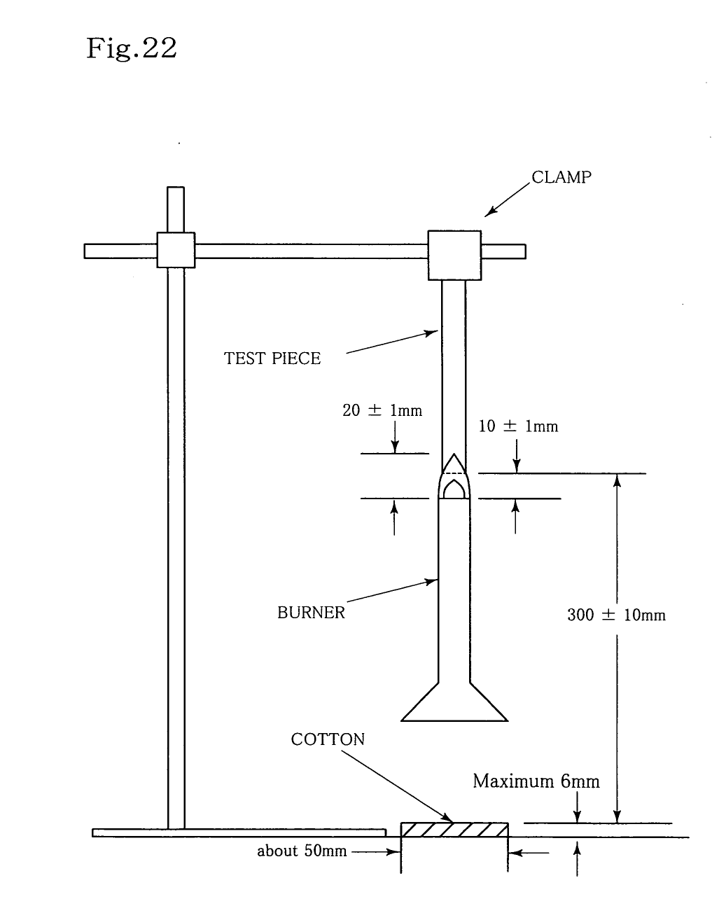

Now, UL94 combustibility test will be explained briefly. First, a rectangular-plate-shaped test piece made of flame-retardant polymer material is prepared. As shown in FIG. 22, the test piece is clinched vertically, and burner and cotton are prepared. The burner is adjusted to make flame be blue flame of 20±1 mm in height. Then, the burner is moved at the position 10±1 mm under from the central portion of the lower end of the test piece, and the test piece is subjected to the flame for 10±0.5 seconds. After that, the burner is kept away 150 mm or more from the test piece, and the afterflame time t₁ is measured. Immediately after the test piece is stopped to burn with flame, the burner is moved back at the position 10±1 mm under from the central portion of the lower end of the test piece, and the test piece is subjected to the flame for 10±0.5 seconds again. Then, the burner is kept away 150 mm or more from the test piece, the afterflame time t₂ and afterglow time t₃ are measured. Test result is determined based on table 11.

TABLE 11

| | V-2 | V-1 | V-0 |
|---|---|---|---|
| Requisitions | A. Afterflame time (t1, t2) of | A. Same as V-2 | A. Afterflame time (t1, t2) of each |
| | each test piece is 30 seconds | | test piece is 10 seconds or less. |
| | or less. | | |
| | B. Sum of afterflame time of | B. Same as V-2 | B. Sum of afterflame time of five |
| | five test pieces is 250 seconds | | test pieces is 50 seconds or less. |
| | or less. | | |
| | C. Sum of afterflame time t2 and | C. Same as V-2 | C. Sum of afterflame time t2 and |
| | afterglow time t3 of each test | | afterglow time t3 of each test piece |
| | piece after the second burning | | after the second burning is 30 |
| | is 60 seconds or less. | | seconds or less. |
| | D. Neither afterflame nor | D. Same as V-2 | D. Same as V-2 |
| | afterglow reaches to a clamp. | | |
| | E. Cotton is ignited by flaming | E. Cotton is not ignited | E. Same as V-1 |
| | particles or materials dropped | by flaming particles or | |
| | from the test piece. | materials dropped from | |
| | | the test piece. | |

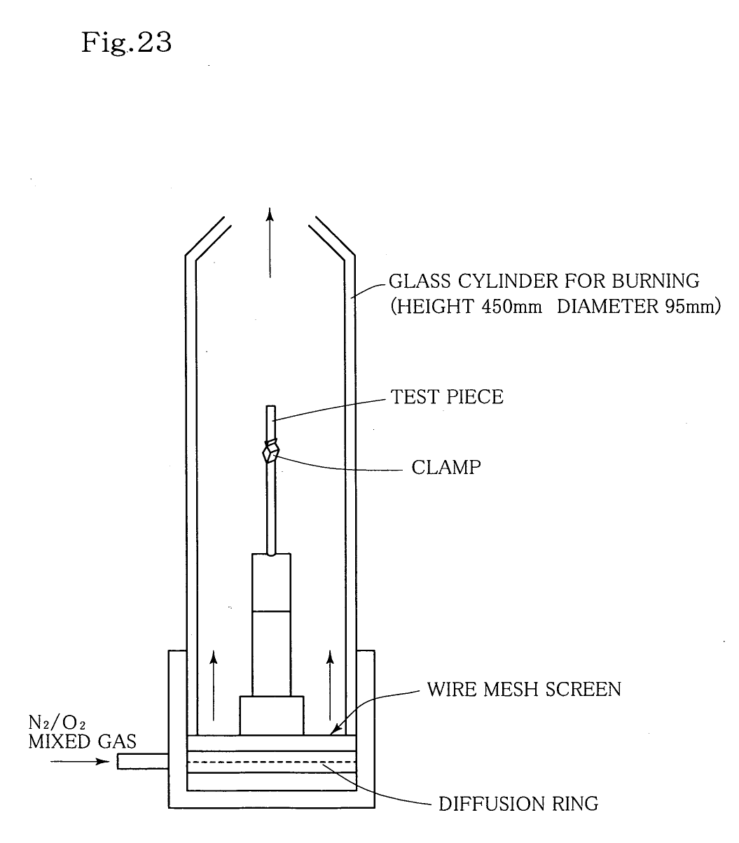

Next, JIS K 7201 combustion test by oxygen index method is explained briefly. With this JIS K 7201 test, minimum oxygen concentration necessary for the test piece to burn with flame (afterflame) is measured by an apparatus as shown in FIG. 23. First of all, a rectangular-plate-shaped test piece is prepared and attached to a clamp. Then, nitrogen gas and oxygen gas are mixed so that the mixed gas has pre-determined oxygen concentration. After supplying the mixed gas to the apparatus, ignite the test piece and confirm that the test piece is burning with flame of the candle state and measure the combustion time.

A: Lower O₂ concentration if combustion time exceeds 3 minutes.

B: Raise O₂ concentration if combustion time is 3 minutes or shorter.

C: Repeat operations A and B, obtain O₂ concentration when the combustion time is 3 minutes, and determine the obtained O₂ concentration as oxygen indexes OI.

It is to be noted that expression of “principal component” or “mainly comprising” was used to specify a component which accounts for a largest content on a weight basis unless otherwise than as specifically described.

1. A flame-retardancy-imparting material containing ammonium nitrate and aluminum hydroxide;
having a content of the ammonium nitrate of 0.05 to 0.2 parts by weight per one part by weight of the aluminum hydroxide.

2. The flame-retardancy-imparting material as claimed in claim 1, wherein the ammonium nitrate has a grain form with an average grain size of 0.01 to 100 μm, and the aluminum hydroxide has a grain form with an average grain size of 0.1 to 100 μm.

3. The flame-retardancy-imparting material as claimed in claim 1, wherein the ammonium nitrate and the aluminum hydroxide are subjected to surface treatment, and
the surface treatment is carried out by using any one treatment agent selected from the group consisting of those of Si-base, Ti-base, Al-base, olefin-base, fatty-acid-base, oil-and-fat-base, wax-base and surfactant-base, and silica or the surface treatment is a coating treatment carried out by using a vitreous precursor composition capable of producing vitreous ceramic upon heating.

4. A flame-retardancy-imparting material containing ammonium nitrate and aluminum hydroxide;
having a content of the ammonium nitrate of 0.05 to 0.2 parts by weight per one part by weight of the aluminum hydroxide;
the ammonium nitrate having a grain form with an average grain size of 0.01 to 100 μm, and the aluminum hydroxide having a grain form with an average grain size of 0.1 to 100 μm; and
the ammonium nitrate being surface-treated with silica, and the aluminum hydroxide being surface-treated with a fatty-acid-base treatment agent.

5. A flame-retardant polymer material having ammonium nitrate and aluminum hydroxide dispersed in a base composed of a polymer material,
having a content of the ammonium nitrate of 1.5 to 14 parts by weight, and having a content of the aluminum hydroxide of 30 to 70 parts by weight, per 100 parts by weight of the polymer material.

6. The flame-retardant polymer material as claimed in claim 5, wherein the ammonium nitrate has a grain form with an average grain size of 0.01 to 100 μm, and the aluminum hydroxide has a grain form with an average grain size of 0.1 to 100 μm.

7. The flame-retardant polymer material as claimed in claim 5, wherein
the ammonium nitrate is surface-treated with silica; and
the aluminum hydroxide is surface-treated with a fatty-acid-base treatment agent.

8. A flame-retardant polymer material having ammonium nitrate and aluminum hydroxide fixed on the surface of a base composed of a polymer material,
having a content of the ammonium nitrate of 1.5 to 14 parts by weight, and having a content of the aluminum hydroxide of 30 to 70 parts by weight, per 100 parts by weight of the polymer material.

9. The flame-retardant polymer material as claimed in claim 8, wherein the ammonium nitrate has a grain form with an average grain size of 0.01 to 100 μm, and the aluminum hydroxide has a grain form with an average grain size of 0.1 to 100 μm.

10. The flame-retardant polymer material as claimed in claim 8, wherein
the ammonium nitrate is surface-treated with silica; and
the aluminum hydroxide is surface-treated with a fatty-acid-base treatment agent.

11. A flame-retardant polymer material mainly comprising a polymer component, wherein such flame-retardant polymer material shows in a spectrum of TDS analysis (thermal decomposition spectroscopy) in vacuo a peak attributable to a combustion-related gas component generated within a combustion temperature range of the polymer component, and a peak attributable to a combustion-inhibitory gas component containing at least a group expressed by COₓ (x is a positive integer) and generated within a temperature range lower than the combustion temperature range of the polymer component.

12. A flame-retardant polymer material mainly comprising a polymer component, wherein such flame-retardant polymer material shows a spectrum of TDS analysis (thermal decomposition spectroscopy) in vacuo in which
a peak profile attributable to a combustible gas component generated by decomposition reaction of the polymer component; and
a peak profile attributable to a non-combustible gas component generated as a decomposition product of the polymer component within a temperature range lower than that responsible for the start of the generation of such combustible gas component.

13. A method for imparting flame retardancy to a polymer material comprising a step of adding aluminum hydroxide and ammonium nitrate to the polymer material, so as to allow the ammonium nitrate to produce a nitrogen oxide and to allow the aluminum hydroxide to produce water when the polymer material is heated to a temperature equal to or lower than the combustion temperature of the polymer material, and so that nitric acid produced by a reaction between the nitrogen oxide and the water denatures the polymer material into a non-combustible material by thermal oxidation to thereby impart flame retardancy to the polymer material.

14. The method for imparting flame retardancy as claimed in claim 13, wherein a content of the ammonium nitrate falls in a range from 0.5 to 20 parts by weight, and a content of the aluminum hydroxide falls in a range from 10 to 100 parts by weight, per 100 parts by weight of the polymer material.

15. The method for imparting flame retardancy as claimed in claim 13, wherein a content of the ammonium nitrate falls in a range from 1.5 to 14 parts by weight, and a content of the aluminum hydroxide falls in a range from 30 to 70 parts by weight, per 100 parts by weight of the polymer material.

16. The method for imparting flame retardancy as claimed in claim 13, wherein the ammonium nitrate has a grain form with an average grain size of 0.01 to 100 μm, and the aluminum hydroxide has a grain form with an average grain size of 0.1 to 100 μm.

17. The method for imparting flame retardancy as claimed in claim 13, wherein
the ammonium nitrate is surface-treated with silica; and
the aluminum hydroxide is surface-treated with a fatty-acid-base treatment agent.

18. The method for imparting flame retardancy as claimed in claim 13, wherein the ammonium nitrate is added to the polymer material after being subjected to drying.
